(19) United States
(12) Patent Application Publication
(10) Pub. No.: US 2026/0288813 A1
(43) Pub. Date: Sep. 24, 2026

(54) SYSTEM

(71) Applicant: SoftBank Group Corp., Tokyo (JP)

(72) Inventor: Kei NISHIKAWA, Tokyo (JP)

(73) Assignee: SoftBank Group Corp., Tokyo (JP)

(21) Appl. No.: 19/567,080

(22) Filed: Mar. 14, 2026

(30) Foreign Application Priority Data
Mar. 19, 2025 (JP) 2025-045017

(51) Int. Cl. G06F 16/3329; G06V 30/10; G10L 15/02

(52) U.S. Cl. CPC G06F 16/33295; G06V 30/10; G10L 15/02; G10L 2015/025

(57) ABSTRACT

A system includes a processor that is configured to obtain audio information and convert the audio information into character data by using a speech recognition technique, obtain image information and extract character data from the image information by using an image recognition technique, and generate a prompt for instructing automatic generation of a document based on the obtained character data and input the prompt to a generative AI model.

### CROSS-REFERENCE TO RELATED APPLICATION

This application is based on and claims priority under 35 USC 119 from Japanese Patent Application No. 2025-045017 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional document preparation for procedures, manuals, and reports largely depends on manual work by human operators. In typical workflows, an operator first records or participates in a meeting, training session, or operation demonstration, then manually listens to the audio, transcribes the content, reviews screenshots or screen recordings, and manually drafts a document. This process is time-consuming, labor-intensive, and prone to human error and inconsistency in style and quality. Furthermore, even when speech recognition tools or image recognition tools are individually available, they are often used in isolation and do not automatically produce a structured document that is suitable for direct use as a manual or report. As a result, the work efficiency of document production remains low and the quality of the resulting documents is highly dependent on the skill and effort of individual operators. Accordingly, there is a need for a system that can automatically obtain audio information and image information, convert these into character data, and, based on the obtained character data, automatically generate a prompt for a generative AI model so that a high-quality document can be generated with reduced manual work and improved consistency.

### SUMMARY

In order to solve the above-described problems, a system is provided comprising a processor, wherein the processor is configured to obtain audio information and convert the audio information into character data by using a speech recognition technique, obtain image information and extract character data from the image information by using an image recognition technique, and generate a prompt for instructing automatic generation of a document based on the obtained character data and input the prompt to a generative AI model. The processor may be configured to obtain the audio information by using recording data of a communication platform, such as a recorded online meeting or presentation, thereby enabling seamless utilization of existing communication environments without additional dedicated recording operations. By inputting the prompt for instructing automatic generation of the document to the generative AI model, the system can automatically generate a document that reflects both spoken content and on-screen text, thereby improving work efficiency and quality of the document.

The term “audio information” refers to sound data including, but not limited to, spoken speech, narration, conversations, or any other audible signals that are to be processed by the system for speech recognition.

The term “character data” refers to data represented in a textual form, such as letters, numbers, symbols, or strings, which are obtained as a result of converting audio information or image information into text.

The term “speech recognition technique” refers to a process or algorithm, implemented by hardware, software, or a combination thereof, that analyzes audio information and converts spoken words contained in the audio information into character data.

The term “image information” refers to data representing visual content, including still images, video frames, screenshots, or other graphical representations, from which text may be extracted.

The term “image recognition technique” refers to a process or algorithm, implemented by hardware, software, or a combination thereof, that analyzes image information and extracts character data or other relevant features from the image information.

The term “prompt” refers to information, including text or structured data, generated by the processor and supplied as input to a generative AI model in order to instruct or guide the model to automatically generate a document.

The term “generative AI model” refers to an artificial intelligence model, such as a machine learning or deep learning model, that generates output content, including but not limited to text documents, in response to an input such as a prompt.

The term “document” refers to any structured or unstructured textual output generated by the generative AI model, including but not limited to manuals, reports, procedure descriptions, operation guides, and similar written materials.

The term “communication platform” refers to a system or service that facilitates communication between users through audio, video, or messaging functions, including but not limited to online meeting systems, web conference systems, and collaboration tools.

The term “recording data of a communication platform” refers to data recorded by the communication platform during a communication session, including audio, video, screen sharing content, or combinations thereof, which can be used as a source of audio information or image information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

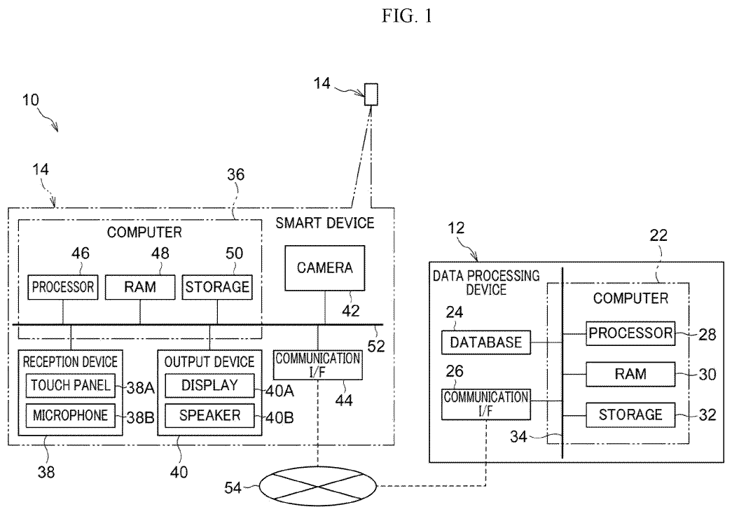

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

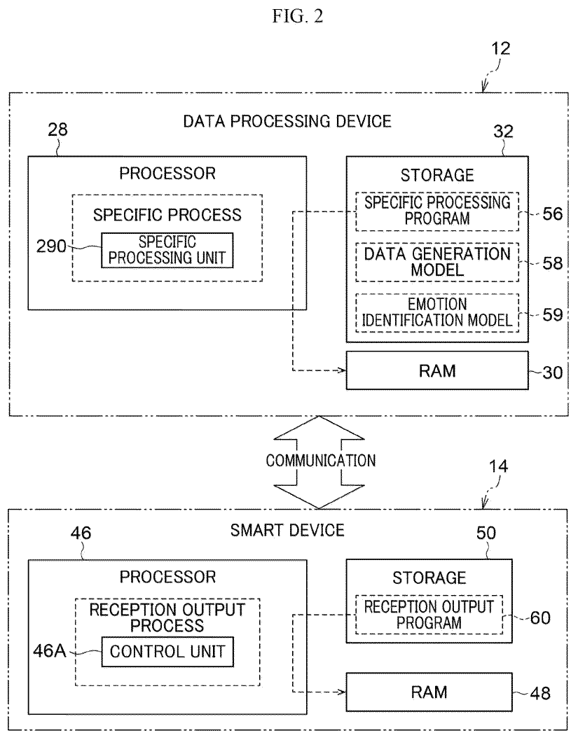

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented document creation workflows for meetings and presentations rely on separate, loosely coupled components for audio transcription, slide capture, and document editing. In many cases, a first computing system performs speech recognition on recorded audio, a second computing system performs optical character recognition on captured images or slides, and human operators manually copy, paste, and reformat the resulting text into structured documents such as minutes or procedure manuals. Because these components are not technically integrated at the system level, the resulting workflows exhibit several technical deficiencies.

First, conventional systems fail to efficiently correlate heterogeneous media streams in a time-synchronized manner within the computing environment. Audio-derived text and image-derived text are often stored as independent files or records without a common temporal index. As a result, computing resources must repeatedly scan, search, and reconcile multiple data sources when generating or updating structured documents. This leads to redundant computation, increased memory usage, and inefficient access patterns on storage devices and communication interfaces.

Second, conventional systems typically treat a generative AI model, if used at all, as a passive text post-processor that receives arbitrary free-form input. The generative AI model is not driven by a structured, programmatically generated prompt that is derived from integrated, time-aligned text data. Therefore, the generative AI model cannot reliably infer the intended document type, section structure, or extraction conditions for actionable items. This causes unpredictable output formats, inconsistent quality, and additional human post-editing. From a computer-technology perspective, the lack of a systematic prompt generation mechanism prevents the generative AI model from being efficiently orchestrated as a deterministic component in an automated pipeline.

Third, conventional systems do not provide an integrated mechanism by which a server both generates a machine-structured document and automatically classifies, stores, and distributes the document in a scalable manner. Document storage locations, file naming, and sharing links are typically configured manually or by separate applications. As a result, the server must perform multiple ad hoc operations across different services, increasing network traffic, I/O overhead, and latency when users attempt to locate or access generated documents.

Accordingly, there is a need for an improved computer-implemented system in which a server acquires recording data, extracts and time-aligns audio-based and image-based character information, programmatically generates a structured prompt sentence and integrated text for input to a generative AI model, and automatically structures, classifies, stores, and shares the resulting document data. Such a system should technically improve the way computing resources are used to transform multi-modal meeting data into structured documents, reduce redundant processing, and provide more predictable and efficient operation of a generative AI model within an end-to-end pipeline.

The specific processing by the specific processing unit 290 of the data processing device 12 in Example 1 is realized by the following means.

The present invention provides a server comprising a processor configured to acquire audio information and image information from recording information, to convert the audio information into character information by a speech recognition process, to convert the image information into character information by an image recognition process, to associate character information based on the audio information and character information based on the image information with each other on the basis of time information to generate integrated text information, to generate a prompt sentence defining instruction content including a document type, structural elements, and a description style for a document on the basis of the integrated text information, to input the prompt sentence and the integrated text information to a generative information processing model and cause the generative information processing model to automatically generate document information, to structure the document information into document data according to a predetermined format and store the document data in a document storage region, to assign classification information to the document data on the basis of meeting information or case information and generate sharing identification information, and to transmit notification information including the sharing identification information to a user terminal by a communication process. This enables the computing system to perform an integrated, time-synchronized transformation of multi-modal recording data into structured documents, to control a generative AI model through a programmatically generated prompt for predictable and efficient document generation, and to automatically manage storage, classification, and distribution of the document data with reduced computational overhead and improved utilization of processing, memory, and communication resources.

The term “recording information” refers to digital data that includes at least an audio component and an image component representing a meeting, a presentation, or another communication session, and that is stored in a storage device as a time-series media stream or file.

The term “audio information” refers to a data portion of the recording information that represents sound, including speech uttered by participants, and that can be processed as an audio signal for speech recognition.

The term “image information” refers to a data portion of the recording information that represents visual frames, including slides, shared screens, or video images, and that can be processed as image data for image recognition.

The term “speech recognition process” refers to a computerized process that analyzes audio information, performs acoustic and language modeling, and converts spoken content in the audio information into machine-readable character information.

The term “image recognition process” refers to a computerized process that analyzes image information, detects regions containing symbols or shapes, and converts visual content, including text within the image information, into machine-readable character information.

The term “character information” refers to text data expressed in a character code format, which is generated by processing audio information or image information and is suitable for storage, search, and further text-based processing.

The term “time information” refers to temporal data, such as timestamps or time indices, that are associated with audio information, image information, or character information, and that allow different pieces of information to be correlated along a common timeline.

The term “integrated text information” refers to character information generated by associating and combining character information based on audio information and character information based on image information on the basis of time information so that the combined text reflects a time-synchronized representation of a session.

The term “prompt sentence” refers to a machine-generated natural language instruction sequence that defines conditions for document generation, including at least a document type, structural elements, and description style, and that is provided as input to a generative information processing model.

The term “document type” refers to a classification of a document according to its intended purpose or format, such as a minutes type, a procedure type, or a summary type, which determines the overall structure and content style of the generated document.

The term “structural elements” refers to components of a document layout, including headings, sections, subsections, lists, and itemized fields, which define the organization of content within the document.

The term “description style” refers to formatting and linguistic conventions for expressing content in a document, including tone, level of detail, use of bullet points or numbered lists, and arrangement of sentences or paragraphs.

The term “generative information processing model” refers to a machine learning model that, based on input data including a prompt sentence and integrated text information, generates new text or document information by predicting and constructing language output.

The term “document information” refers to generated content output by the generative information processing model, which represents the substantive text of a document before being converted into a specific file format or structured data representation.

The term “document data” refers to structured data obtained by arranging document information according to a predetermined format or template, such as a word processing format or markup structure, suitable for storage, display, and distribution.

The term “predetermined format” refers to a pre-defined layout specification or template that determines how document information is organized, including styles for titles, headings, paragraphs, lists, and metadata fields.

The term “document storage region” refers to a logical or physical storage area, such as a directory, database, or repository, in which document data is stored and managed by the server.

The term “meeting information” refers to metadata related to a session, including at least one of a meeting name, date, time, participants, project identifier, or agenda, which can be associated with document data for classification purposes.

The term “case information” refers to metadata related to a business case, project, or task, including identifiers, titles, categories, or statuses, which can be associated with document data for organizing documents by subject matter.

The term “classification information” refers to information that indicates how document data is categorized, including labels, tags, folders, or hierarchical identifiers that are derived from meeting information or case information.

The term “sharing identification information” refers to data that identifies access to document data for sharing purposes, including a link, token, identifier, or address that allows authorized user terminals to access the document data.

The term “notification information” refers to data transmitted from the server to a user terminal that includes at least the sharing identification information and may further include descriptive text such as a document summary, title, or usage instructions.

The term “user terminal” refers to an information processing device operated by a user, such as a personal computer, a portable information terminal, or a communication device, that can receive notification information and access document data via a communication network.

The term “communication process” refers to a set of operations in which data, including notification information and document-related information, is transmitted and received between the server and one or more user terminals or external services via a communication network.

In one embodiment, a server, a terminal, and a communication network cooperate to implement the claimed system. The server includes at least one processor, a main memory, a nonvolatile storage device, and a network interface. The terminal includes at least one processor, a display, an input device, an audio input device, an image input device, a local storage device, and a communication interface. The server and the terminal execute various software components to acquire recording information, generate integrated text information, construct a prompt sentence, invoke a generative AI model, and store and distribute structured document data.

The terminal executes communication software such as a conferencing application implemented using general-purpose communication libraries, audio/video codecs, and user interface components. The terminal captures a user's audio via a microphone and a user's video and shared screen via a camera and a screen capture module. The terminal encodes the captured audio and video using typical codecs such as a linear PCM format or a compressed format for audio and a block-based transform codec for video. The terminal encapsulates the encoded streams into a container format such as MP4 and transmits the container to a remote recording service over a packet-switched network using standardized transport protocols such as an RTP-based streaming stack or an HTTP-based upload.

The server receives or acquires the recording information as a time-series media file or stream that includes at least one audio track and at least one video track. The server runs multimedia processing software such as FFmpeg on the processor to demultiplex the container and to separate the audio information and the image information. The server extracts the audio track as an audio file (for example, a WAV file in 16-bit PCM format) and extracts video frames as image files (for example, PNG images at a specified frame rate). The server stores file paths and associated timestamps of the audio information and image information in a structured data store, such as a relational database system, and uses explicit primary keys and foreign keys to maintain the relationship between the recording information and each derived component.

The server applies a speech recognition process to the audio information. In one embodiment, the server implements a speech recognizer as a deep neural network based on a sequence-to-sequence architecture with an encoder-decoder structure. The server processes the audio information by first applying signal processing steps such as framing, windowing, and discrete Fourier transform to compute short-time spectra. The server calculates mel-frequency cepstral coefficients or log-mel filterbank energies as acoustic feature vectors. The server normalizes the feature vectors and inputs them to an acoustic encoder network composed of multiple layers of recurrent units or attention-based transformer blocks. The encoder outputs a sequence of hidden feature vectors representing the temporal structure of the speech.

The server then uses a decoder network that receives the encoder output and produces a sequence of grapheme or subword tokens corresponding to recognized speech content. The server trains the speech recognition network using supervised learning with labeled audio-text pairs. The server applies a loss function such as a connectionist temporal classification loss or a cross-entropy loss on token sequences and updates network weights by gradient-based optimization such as stochastic gradient descent or an adaptive moment estimation method. The server may perform data augmentation on training audio by adding synthetic noise, reverberation, or speed perturbation to improve robustness. At runtime, the server decodes the probability distribution over tokens using a beam search algorithm constrained by a language model to output character information that represents spoken utterances with timestamps per token or per word.

The server applies an image recognition process to the image information. In one embodiment, the server executes an optical character recognition engine based on a convolutional neural network and a recurrent neural network. The server preprocesses each image frame by resizing, grayscale conversion, and binarization. The server performs text region detection by applying a region proposal network or a connected component analysis algorithm. The server then normalizes each detected region and passes it to a character recognition network. The server uses convolutional layers to extract spatial features and uses recurrent layers or attention mechanisms to model character sequences across the region. The server trains the OCR network on labeled image-text datasets with a sequence loss similar to the speech recognizer. The server outputs character sequences with bounding box coordinates and confidence scores as character information derived from the image information.

The server stores both sets of character information—audio-based and image-based—together with their respective time information. The server maintains a temporal index structure, for example, a table with fields including recording identifier, start time, end time, modality type (audio or image), and character payload. The server aligns character information from the different modalities by comparing their time ranges and applying a temporal alignment algorithm. In one embodiment, the server divides the entire time axis of the recording into fixed-length segments and assigns each character sequence to one or more segments based on timestamp overlap. The server then merges the character sequences within each segment into an integrated text information structure.

The server represents the integrated text information as a hierarchical data structure such as a sequence of blocks, wherein each block includes a block type (for example, spoken content or slide content), a time range, and a text field. The server may insert delimiters such as “[SLIDE TEXT START]” and “[SLIDE TEXT END]” around OCR-derived content to preserve modality provenance. By normalizing all content into this integrated text representation, the server reduces later processing overhead, because the generative AI model receives an already time-aligned and modality-annotated sequence, avoiding repeated cross-referencing between separate sources.

The server generates a prompt sentence for a generative AI model based on the integrated text information. The server executes prompt-construction logic that examines the integrated text information, identifies candidate headings, agenda items, or topics by scanning for keywords in slide titles and spoken introductions, and selects an appropriate document type. For example, if the integrated text information includes phrases indicating decisions or tasks, the server selects a minutes-type document. If the integrated text information includes stepwise instructions and warnings, the server selects a procedure-type document. The server constructs a prompt sentence in natural language including explicit instructions regarding document type, structural elements, and description style.

In one example, the server constructs a prompt sentence of the following form:
“You are a professional documentation assistant. Using the following combined transcript and slide text, generate structured meeting minutes. Include the sections: 1) Agenda, 2) Key Discussion Points, 3) Decisions, 4) Action Items (with assignees and due dates). Use clear headings and bullet points. Combined text: [INSERT_COMBINED_TEXT].”

In another example, the server constructs a prompt sentence of the following form:
“Create a step-by-step procedure document from the following meeting transcript and slide text. Organize the output into: Purpose, Prerequisites, Step-by-Step Instructions, and Cautions. Use numbered lists for steps. Source text: [INSERT_COMBINED_TEXT].”

In a further example, the server constructs a prompt sentence of the following form: “From the following transcript, extract all action items in the form: ‘Owner-Task-Due date’. Summarize them in a table-like text. Transcript: [INSERT_TRANSCRIPT].”

The server then inputs the constructed prompt sentence and the integrated text information to a generative information processing model. In one embodiment, the generative AI model is implemented as an autoregressive transformer network with multiple self-attention layers. The server tokenizes the prompt sentence and the integrated text information into subword tokens and concatenates them as a single token sequence. The server feeds the token sequence into the transformer model. The model uses multi-head self-attention to compute contextual representations of each token and uses feedforward layers to transform these representations. The final output layer produces a probability distribution over the vocabulary for each next token. The server configures decoding parameters such as beam width, temperature, and length penalties to balance determinism and diversity in the generated text.

The generative AI model is trained on large corpora of text data using a maximum likelihood objective that minimizes cross-entropy loss between predicted tokens and reference tokens. The server may fine-tune the model on domain-specific documents such as technical minutes and procedure manuals. During training, the server performs backpropagation to compute gradients of the loss with respect to model parameters and updates weights using optimization algorithms. The server can perform data augmentation by reordering sections, inserting artificial markers, or combining multi-modal text representations to improve the model's ability to handle integrated text information.

This architecture provides a technical improvement over manual or loosely coupled systems because the prompt sentence is generated programmatically from a structured, time-aligned data representation. The server uses explicit rules, temporal indices, and modality markers to construct the prompt. As a result, the generative AI model receives input that is already organized for the target document type, thereby reducing the computational work needed to infer structure and decreasing the likelihood of inconsistent output. The integrated design reduces model calls, improves cache locality when accessing integrated text, and lowers communication overhead between the server and external AI services.

The server converts the output of the generative AI model into document information. The server segments the generated text on the basis of heading markers and list markers and maps these segments to a document schema including fields such as title, date, agenda, decisions, and action items. The server converts the document information into document data according to a predetermined format, for example by constructing a word-processor document with explicit styles for titles, headings, paragraphs, and bullet lists. The server stores the document data in a document storage region such as a file repository or a document management system. The server writes metadata for each document, including meeting information and case information, into an index table.

The server assigns classification information to the document data based on meeting information or case information. The server may derive a project identifier, a date, and a topic from the integrated text information and from explicit metadata in the recording information. The server generates a hierarchical storage path and associates classification tags with the document data. The server then creates sharing identification information, such as a unique access token or link that references the stored document. The server registers access control policies, for example by associating user identifiers or group identifiers with the sharing identification information.

The server sends notification information including the sharing identification information to the terminal. The server composes a notification message and transmits it over the network using a messaging protocol. The terminal receives the notification information, displays a message on a display device, and, upon user interaction, opens the document in a viewer application. By managing classification and distribution in an automated manner, the server reduces manual search and retrieval operations that would otherwise consume network and storage resources.

From a technical standpoint, the system improves computer technology in several ways. The server's use of time information to integrate audio-derived and image-derived character information reduces random access patterns and cross-file lookups compared with conventional workflows that store each modality separately. The explicit integrated text representation allows the server to process content in a single pass when constructing the prompt sentence, thereby lowering CPU cycles and memory consumption. The rule-based prompt generation module guides the generative AI model to produce structured, predictable output, which decreases the need for repeated inference calls and post-processing corrections, thereby reducing computation and latency.

Furthermore, the use of specialized neural architectures for speech recognition and OCR, combined with multimodal temporal alignment, improves the accuracy of captured text relative to independent, unaligned recognition systems. Because the server aligns slide text with spoken commentary, the generative AI model can more accurately infer context, yielding fewer errors in the resulting document. This reduces error-correction operations and improves throughput.

The server performs these operations using specific data structures such as temporal index tables, modality-labeled blocks, and schema-based document representations. This is not a mere automation of human reading and writing, but an engineered pipeline that optimizes the flow of media data through specialized algorithms and models. The server applies explicit alignment rules, structured prompt composition, and template-based document structuring that have no direct analog in manual procedures. These technical measures collectively enhance processing speed, accuracy, and resource utilization when transforming multi-modal recordings into structured documents.

Alternative embodiments are also possible. In one variation, the server executes the generative AI model locally on a dedicated hardware accelerator such as a graphics processing unit or a tensor processing unit, rather than calling a remote AI service. In another variation, the server uses different neural network architectures for speech recognition, such as a conformer network that combines convolutional and attention layers, or uses a CTC-only model for lower latency. In yet another variation, the server performs slide-change detection by computing hash values or feature vectors of consecutive frames and selecting only frames that exceed a difference threshold, thereby reducing the number of OCR operations and lowering computational load.

In some embodiments, the server adjusts prompt sentences dynamically based on detection of meeting type. For example, if the server detects repeated use of terms associated with problem resolution, the server modifies the prompt sentence to emphasize extraction of issues and resolutions. In other embodiments, the server enforces strict token-length limits and splits the integrated text information into multiple segments, generating separate prompt sentences for each segment while preserving cross-segment context identifiers. These variations demonstrate that the claimed system is not limited to a specific business flow, but rather to a set of technical mechanisms for acquiring, aligning, generating, and managing document data using a generative AI model controlled by structured prompt sentences.

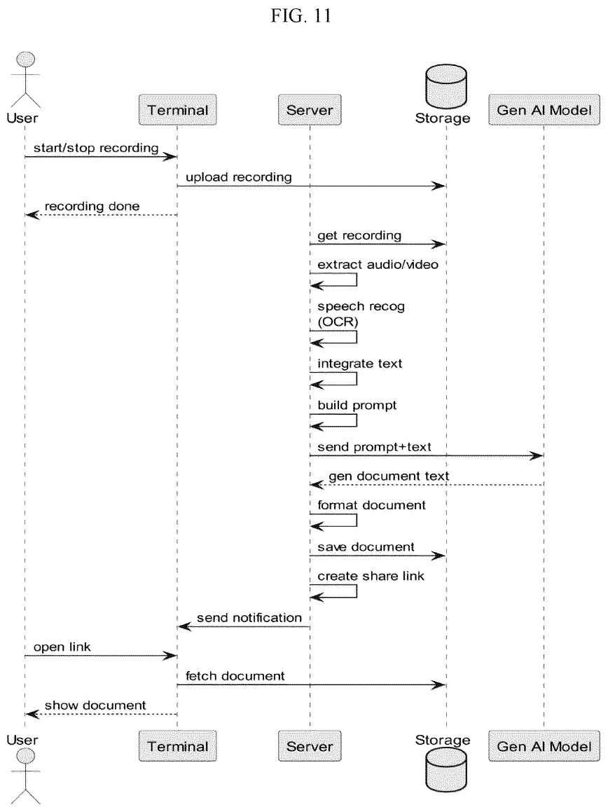

The following describes the processing flow using FIG. 11.

### Step 1:

The user operates the terminal to start a meeting or presentation using conferencing software.

The user presses a recording control on the terminal to begin and end recording.

Input: user operations (start/stop recording), audio captured by a microphone, video and screen images captured by cameras and screen capture modules.

Output: a live audio-video stream delivered from the terminal to a recording service or stored locally as recording information.

The terminal encodes the audio into an audio stream, encodes the video and screen into a video stream, multiplexes them into a container format, and transmits or writes the resulting recording information to a storage device.

### Step 2:

The server acquires recording information from a storage system or a communication platform.

Input: a stored audio-video container file or stream identifier corresponding to a recorded meeting or presentation.

Output: separated audio information and image information extracted from the recording information.

The server executes a multimedia processing program to demultiplex the container, to decode the audio track into an audio file, and to sample the video track at defined time intervals to generate a sequence of image frames.

### Step 3:

The server applies a speech recognition process to the audio information to generate character information.

Input: audio information in a defined waveform format (for example, a PCM-encoded audio file with time indices).

Output: character information sequences representing spoken utterances and associated time information for segments or tokens.

The server computes acoustic feature vectors from the audio signal, feeds the feature vectors into a trained neural network for speech recognition, and decodes the resulting probability distributions into text segments with timestamps.

### Step 4:

The server applies an image recognition process including optical character recognition to the image information to generate additional character information.

Input: image information consisting of multiple captured frames with associated timestamps.

Output: character information sequences representing text contained in the images and associated time information and confidence values.

The server preprocesses each image, detects potential text regions, performs character sequence recognition on each region using an OCR model, and consolidates recognized strings into text blocks linked to the original frame timestamps.

### Step 5:

The server aligns and integrates character information from audio and character information from images into integrated text information.

Input: character information derived from audio with time information, and character information derived from images with time information.

Output: integrated text information comprising a time-ordered sequence of blocks that indicate modality type, time range, and text content.

The server divides the recording timeline into segments, assigns each character sequence to one or more segments based on temporal overlap, and merges sequences within the same segment while inserting modality markers and preserving ordering.

### Step 6:

The server analyzes the integrated text information and generates a prompt sentence for a generative AI model.

Input: integrated text information including modality markers, timestamps, and detected keywords from spoken content and slide text.

Output: a prompt sentence in natural language that specifies a document type, structural elements, and a description style, plus a prepared text block for model input.

The server scans the integrated text for indicator terms related to agenda, decisions, action items, or procedural steps, determines an appropriate document type such as minutes or procedure, and constructs a prompt sentence that instructs the generative AI model how to organize and format the document.

### Step 7:

The server provides the prompt sentence and the integrated text information to the generative AI model and obtains generated document information.

Input: a tokenized combination of the prompt sentence and integrated text information.

Output: generated document information in the form of a continuous textual draft organized according to the instructions in the prompt sentence.

The server encodes the inputs into tokens, calls a transformer-based generative information processing model, receives predicted tokens that form the document, and decodes the tokens into human-readable text paragraphs and headings.

### Step 8:

The server structures the generated document information into document data according to a predetermined format.

Input: generated document information as unstructured or semi-structured text output from the generative AI model.

Output: document data mapped to a defined schema with fields for metadata, headings, paragraphs, lists, and other structural elements.

The server parses the generated text for heading markers, list indicators, and section delimiters, maps each segment to predefined styles or schema elements, and constructs a document object that can be exported in one or more document file formats.

### Step 9:

The server stores the document data in a document storage region and associates classification information with the document data.

Input: structured document data and metadata including meeting information and case information.

Output: a stored document record with a persistent identifier, a physical or logical storage location, and associated classification information.

The server writes the document file into a storage system, records its location and identifier in an index, and attaches classification tags such as project identifiers, dates, and subject categories for efficient retrieval.

### Step 10:

The server generates sharing identification information for the document data and prepares notification information.

Input: stored document data, its storage identifier, and classification information.

Output: sharing identification information such as an access link or token, and notification information containing the sharing identification information and descriptive text.

The server creates a unique address or token that references the stored document, configures access policies, composes a notification message including document title and summary, and embeds the sharing identification information into the message.

### Step 11:

The server transmits the notification information to the terminal, and the user accesses the generated document.

Input: notification information including sharing identification information and destination information for the terminal or user account.

Output: a displayed message at the terminal and a requested document view when the user selects the sharing identification information.

The server sends the notification message over a communication network, the terminal receives and displays the message, the user activates a link or control to request the document, and the terminal retrieves and presents the document data from the storage region using the provided sharing identification information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented document creation systems require human operators to manually interpret recordings of meetings or training sessions, manually combine spoken content with on-screen content, and manually organize the combined content into structured procedure documents or safety documents. Even where speech recognition and optical character recognition are available as stand-alone tools, such tools are typically used in isolation and produce unstructured text outputs that must be extensively edited, reformatted, and filed by the user. This results in significant processing latency, inconsistent document quality, and high operator workload.

Furthermore, generic text generation engines and generative AI models, when used in a naïve manner, operate on unstructured prompts that do not fully reflect the temporal relationships between spoken instructions and on-screen information. As a result, such models may generate incomplete or misleading procedures, omit critical safety information, or fail to conform to factory-specific document formats. From a computer technology perspective, existing systems do not provide an integrated, machine-executable pipeline that: (i) systematically fuses multi-modal inputs (audio and image streams) into time-series structured information; (ii) automatically derives document structure data aligned with predefined templates; and (iii) programmatically constructs optimized prompt sentences and context inputs tailored to a generative AI model.

In addition, known document management systems often treat generated files as opaque payloads, relying on manual naming and filing operations. This leads to poor retrieval performance and difficulty in maintaining versioned, role-based access to critical operation manuals and safety guidelines. There is therefore a need for a computer-implemented technique that improves the way computing devices process multi-modal meeting and training data, generate and refine structured documents via generative AI models, and automatically classify and share the resulting documents, thereby improving the efficiency, reliability, and technical quality of document generation and management operations performed by the computing system itself.

The specific processing by the specific processing unit 290 of the data processing device 12 in Application Example 1 is realized by the following means.

The present invention provides a server comprising a processor and a memory storing instructions that, when executed by the processor, cause the processor to acquire audio information and convert the audio information into character information by using a speech recognition technique; acquire image information and extract character information from the image information by using a character recognition technique; integrate the acquired character information on the basis of time information to generate time-series structured information including procedure information, safety information, and supplementary information; generate document structure data in accordance with a document format for a procedure document or a safety document on the basis of the time-series structured information and document type information; generate a prompt sentence including content for instructing automatic generation of a document on the basis of the document structure data, and input the prompt sentence and the time-series structured information into a generative information processing model; convert document content output from the generative information processing model into document data in a format conforming to the document format; and store the document data automatically in a predetermined classification region within a storage region on the basis of attribute information included in the document data and provide reference information to the document data to a related terminal on the basis of sharing destination information. This enables the computing system to technically improve the processing of multi-modal recording data by automatically transforming raw audio and image streams into integrated time-series structured information, optimizing context and prompt sentences for interaction with a generative AI model, generating standardized and template-conformant documents with reduced human intervention, and performing automated classification and distribution of the resulting document data, thereby enhancing computational efficiency, consistency of outputs, and overall performance of computer-based document generation and management.

The term “audio information” refers to data representing sound signals, including, for example, spoken utterances captured during a meeting, training session, or other event, which are stored or processed in a digital or analog form.

The term “image information” refers to data representing visual content, including, for example, still images or video frames that depict slides, user interfaces, or other on-screen or camera-captured scenes.

The term “character information” refers to textual data expressed as sequences of symbols, such as letters, numerals, and punctuation marks, which are suitable for storage, search, editing, and further processing by a computing device.

The term “speech recognition technique” refers to a computer-implemented procedure that analyzes audio information and outputs corresponding character information representing the linguistic content of spoken utterances.

The term “character recognition technique” refers to a computer-implemented procedure, such as optical character recognition, that analyzes image information and outputs character information corresponding to text contained in the image information.

The term “time information” refers to temporal data associated with audio information, image information, or character information, such as timestamps or time indices, that indicate when a particular segment of data occurs within a recording or processing timeline.

The term “time-series structured information” refers to data that organizes character information, including procedure information, safety information, and supplementary information, along a temporal axis based on time information, thereby expressing relationships between different pieces of information over time.

The term “procedure information” refers to character information that represents ordered steps, actions, or operations to be performed in order to carry out a task, process, or workflow.

The term “safety information” refers to character information that represents precautions, warnings, prohibitions, or other measures intended to prevent accidents, injuries, or damage during performance of a task or operation.

The term “supplementary information” refers to character information that provides additional context, explanations, notes, or references that support understanding of procedure information or safety information.

The term “document structure data” refers to data representing an arrangement of sections, headings, paragraphs, lists, and other structural elements of a document, without necessarily including fully determined textual content of each element.

The term “document format” refers to a predefined structural specification or template for a document, including rules regarding section ordering, heading levels, itemization styles, and layout constraints for particular types of documents, such as procedure documents or safety documents.

The term “document type information” refers to data indicating a category or class of document to be generated, such as an operation manual, a safety guideline, a training summary, or another standardized document type.

The term “prompt sentence” refers to a sequence of character information used as an instruction or query for a generative information processing model, the sequence specifying desired content, structure, style, or constraints for automatically generated text.

The term “generative information processing model” refers to a machine-learned model or other information processing mechanism that generates new character information in response to an input including a prompt sentence and contextual data.

The term “document content” refers to character information output from the generative information processing model that is intended to constitute the substantive textual portion of a document.

The term “document data” refers to data representing a document in a machine-readable storage format, including both document content and structural or layout information conforming to a document format.

The term “attribute information” refers to metadata associated with document data, such as category labels, keywords, equipment identifiers, process identifiers, language indicators, creation times, or version identifiers, which are used for classification or retrieval.

The term “classification region” refers to a logical or physical subdivision of a storage region, such as a directory, folder, partition, or database collection, that is associated with particular attribute information and is used to store document data having matching attributes.

The term “storage region” refers to a memory or storage resource, such as a file system, database, or other persistent storage medium, that is accessible to the server for storing document data and related information.

The term “sharing destination information” refers to data that specifies one or more recipients, computing devices, user accounts, or groups to which reference information for particular document data is to be provided.

The term “reference information” refers to data that allows a related terminal or user to access or identify specific document data, such as a uniform resource locator, file path, document identifier, or other access token.

The term “related terminal” refers to a computing device operated by a user, such as a client computer, mobile device, or workstation, that is configured to receive reference information from the server and access document data stored in the storage region.

The term “communication processing apparatus” refers to a computing device, such as a client terminal or network node, that acquires recording information of a meeting or training session and transmits the recording information to the server or makes the recording information available for processing.

The term “recording information” refers to data representing a recorded meeting, training session, or similar event, the data including at least audio information and image information and optionally associated metadata such as time information and participant information.

The term “screen image” refers to an image, such as a frame extracted from video information, that depicts content displayed on a screen during a meeting or training session, including slides, user interface elements, or other visual information.

In one embodiment, a server implements the claimed system by executing a computer program stored in a non-transitory storage medium. The server comprises at least one processor, a main memory, and a storage device connected through a bus, and communicates with one or more terminals over a network. The server executes dedicated software modules for audio processing, image processing, time-series integration, document structuring, prompt sentence generation, interaction with a generative AI model, and document storage and sharing. The server can be implemented on general-purpose server hardware, such as an x86 or ARM-based machine running an operating system such as a server-oriented operating system, and can use a programming environment such as a high-level scripting language runtime.

The server uses an audio processing module to implement the speech recognition technique. The server acquires audio information from recording information received from a communication processing apparatus or directly from a terminal. The recording information can be in a container format including both audio streams and video streams. The server optionally uses a multimedia framework to separate the audio stream from the container. The server then performs speech recognition using a speech recognition library such as a speech recognition framework or an automatic speech recognition (ASR) engine that may be based on a neural network model such as a recurrent neural network, a convolutional neural network, or a transformer-based acoustic model with a connectionist temporal classification loss. The server converts the audio information into character information by passing the digitized audio samples through a feature extraction pipeline that computes features such as Mel-frequency cepstral coefficients, log-mel spectrograms, or filterbank energies, and then feeding the features into the trained ASR model to obtain decoded text sequences.

The server uses an image processing module to implement the character recognition technique. The server acquires image information by extracting frames from the video stream within the recording information. The server uses an image processing library such as an image analysis framework to decode video frames. The server can downsample, crop, or otherwise pre-process the frames to focus on regions likely to contain text, for example by applying edge detection, binarization, and contrast enhancement. The server then supplies these frame images to an optical character recognition (OCR) engine such as an OCR library, which internally uses a neural network-based OCR model or a hybrid rule-based and statistical model to recognize characters. The OCR engine converts raster pixel data into character information by segmenting text regions, classifying character shapes, and assembling them into words and lines, outputting character information from each frame.

The server associates each piece of character information obtained from audio and each piece of character information obtained from image information with time information. The server uses the time indices present in the audio and video streams or assigns timestamps based on frame indices and audio sample indices. The server stores the character information and corresponding time information in a structured data store, for example as records in a relational database or as time-indexed entries in a document-oriented database. The server thus generates time-series structured information that arranges procedure information, safety information, and supplementary information along a temporal axis.

The server applies specific integration rules to derive procedure information and safety information from the raw character information. For example, the server uses pattern recognition rules that detect indicative phrases such as “Step 1,” “Next, the operator should,” “Warning,” or “Caution” and associates them with nearby text segments within a temporal window. The server can further apply a sequence labeling algorithm, such as a conditional random field or a neural sequence tagger, to assign labels such as “PROCEDURE_STEP,” “SAFETY_NOTICE,” or “BACKGROUND_INFO” to each text segment. By combining the classification results with time information, the server constructs a time-series structured information object in which each time interval contains labeled segments of character information.

The server uses a document structuring module to generate document structure data from the time-series structured information. The server selects a document format based on document type information, such as whether the target is a procedure document or a safety document. The server maintains one or more document templates in a template store. Each document template defines sections, headings, and layout rules, such as a “Purpose” section, a “Tools Required” section, a “Step-by-Step Procedure” section, and a “Safety Warnings” section. The server translates the time-series structured information into document structure data by mapping labeled text segments into corresponding sections of the selected template. For example, segments labeled as procedure information are placed into a sequence of steps, while segments labeled as safety information are grouped into a warnings section.

The server generates a prompt sentence that will be provided to a generative AI model together with context derived from the document structure data and the time-series structured information. In one embodiment, the server constructs the prompt sentence by concatenating fixed instruction phrases with variable parts reflecting the document type, target audience, desired level of detail, and language preference. The server can generate a prompt sentence such as:
“Based on the following transcript segments and on-screen text, generate a standardized operation procedure document for the new machine, including clear numbered steps, safety warnings, and troubleshooting tips, following the specified document format.”
or
“Using the integrated time-series text below, create a safety guideline document that groups all safety-related statements into a dedicated section and paraphrases them in clear and concise language for factory operators.”

The server attaches the time-series structured information and metadata, such as section boundaries and labels, to the generated prompt sentence, thereby forming an input package for the generative AI model.

The server interacts with a generative AI model that functions as a generative information processing model. In one embodiment, the generative AI model is implemented as a large-scale transformer-based neural network including multiple self-attention layers, feed-forward layers, and positional encoding. The model has been trained in advance on a large corpus of text and further fine-tuned on a domain-specific corpus containing operation manuals and safety guidelines. The training of the generative AI model involves minimizing a language modeling loss function such as cross-entropy between predicted token distributions and ground-truth tokens, using stochastic gradient descent or a related optimizer such as Adam. During training, the server or a training system performs weight updates based on backpropagation, employs data augmentation techniques such as synonym substitution or paraphrasing to increase robustness, and applies regularization techniques such as dropout and layer normalization to improve generalization.

At runtime, the server configures the generative AI model by setting generation parameters, such as temperature, maximum token length, and penalty parameters that control repetition or diversity. The server sends the prompt sentence and a representation of the time-series structured information to the generative AI model. The generative AI model processes the input sequence, computing attention scores between prompt tokens and context tokens to identify relevant portions of the time-series structured information, and outputs token sequences that constitute document content. The server decodes the generated tokens into character information, which forms an AI-generated draft of the document.

The server post-processes the AI-generated document content to ensure consistency with the document format and to improve technical quality. For example, the server applies rule-based validators that check for the presence of mandatory sections, verify that procedure steps are numbered in order, and ensure that specific safety phrases, such as instructions for emergency stop procedures, are present when relevant equipment names are detected. The server may also recalibrate the generative AI model's output by feeding back selected sections with updated prompt sentences, such as:
“Refine the following step-by-step procedure to remove ambiguity and ensure that each step begins with a verb, while preserving all safety-related instructions.”

The server then merges the validated content with the document structure data and generates document data in a target file format such as a word processing format or a portable document format. The server can use a document generation library to construct the file, applying styles, headings, and numbering consistent with the document format.

The server assigns attribute information to the generated document data, including identifiers for equipment, production lines, document types, languages, and creation times. Using these attributes, the server determines a classification region within a storage region, for example identifying a directory or a database partition corresponding to a particular equipment type and language. The server automatically stores the document data in the appropriate classification region. The server then generates reference information, such as a unique document identifier or a network-accessible path, and transmits this reference information to one or more related terminals based on sharing destination information stored in the system. The server can send the reference information via electronic mail, a messaging protocol, or an application programming interface.

The terminal presents a user interface that allows a user to trigger recording, review generated documents, and provide additional instructions via prompt sentences. The terminal can be a mobile device, a tablet, or a workstation. The terminal acquires audio and video through local sensors, such as microphones and cameras, and forwards recording information to the server. The terminal receives reference information and opens the corresponding document data for viewing or editing using local applications.

The user records a meeting or training session using the terminal and later accesses a web interface provided by the server to initiate document generation. The user can select the document type and specify desired characteristics for the output. The user may directly edit or approve the automatically generated prompt sentence, or can input a custom prompt sentence such as:
“From this training session, generate a bilingual operation manual, listing each step first in the original language and then in English, and ensure that all warnings are highlighted in a separate subsection.”

By enabling the user to specify such instructions, the system configures the generative AI model to produce outputs that conform to domain-specific requirements while benefiting from the model's generalized language capabilities.

The described configuration improves computer technology in several ways. The server does not merely automate a human workflow; instead, the server performs a non-conventional integration of multi-modal data and constructs structured machine-readable representations that are not typically created manually. By aligning speech-derived and image-derived character information with fine-grained time information and labeling segments as procedure, safety, or supplementary information, the server forms an optimized input representation that allows the generative AI model to focus attention on relevant content. This structured context improves generation accuracy and reduces the need for human correction, thereby directly enhancing computational efficiency and reducing processing time.

In addition, the server's automatic classification and storage of document data based on attribute information improves data management within the computer system. By algorithmically mapping attribute combinations to classification regions, the server minimizes search time and retrieval overhead compared to systems requiring manual filing. The time-series structured information and document structure data are stored in normalized data structures, which reduces redundancy and supports efficient querying for purposes such as partial regeneration of sections or targeted updates when new training recordings become available.

The generative AI model, as implemented, employs a specific neural network architecture and training method to handle the fusion of prompt sentences with time-series structured information. The model uses distinct input embeddings for tokens originating from prompt instructions versus tokens originating from transcript segments or OCR-derived text, allowing the attention mechanism to learn differential weighting for instruction versus content. During fine-tuning, the training system uses task-specific labels, such as section boundaries and step identifiers, to bias the model toward producing well-structured documents. The error function includes terms that penalize deviations from desired section order or missing mandatory headings, and weight updates are computed accordingly. These design choices cause the system to generate structurally consistent documents at higher accuracy compared to generic text generation systems, thereby providing a concrete technical improvement in text generation quality.

The AI-based processing in this system uses rules and learned representations that differ from traditional human editing practices. For example, the server processes the time-series structured information to identify overlapping or contradictory statements by computing similarity scores between segments using vector embeddings and resolving conflicts with deterministic tie-breaking rules. The server may compress repetitive instructions before providing context to the generative AI model, thereby reducing communication load between the server and the AI processing hardware and conserving computational resources during inference.

In another embodiment, the server hosts the generative AI model locally on graphics processing units or specialized accelerators. The server partitions the model into multiple modules deployed across different processing devices to achieve parallelism. The server uses a scheduling algorithm to batch multiple requests with similar document types, thereby amortizing the computational cost of model invocation and improving throughput. The batched processing reduces network latency and lessens contention for external AI services, contributing to communication load reduction and improved system responsiveness.

In yet another embodiment, the server uses an alternative speech recognition technique based on an end-to-end transformer acoustic model and an alternative character recognition technique using a convolutional recurrent neural network for OCR. The server can also use alternative document templates and prompt sentence construction rules, while still operating according to the same overall architecture. For example, the system can be configured to generate maintenance logs, inspection reports, or training summaries in addition to operation manuals and safety guidelines, simply by modifying the document type information and template definitions.

In all these embodiments, the server, the terminal, and the user cooperate in a way that allows the server to perform technically meaningful changes to the internal operation of the computer system. By implementing a specialized pipeline of multi-modal data fusion, time-series structuring, template-driven document composition, and prompt sentence optimization for a generative AI model, the system achieves improved processing speed, higher accuracy in document generation, reduced human correction workload, and more efficient storage and retrieval of document data. These benefits arise from specific data structures, algorithms, and neural network configurations implemented within the computing system, and therefore constitute improvements to computer technology itself.

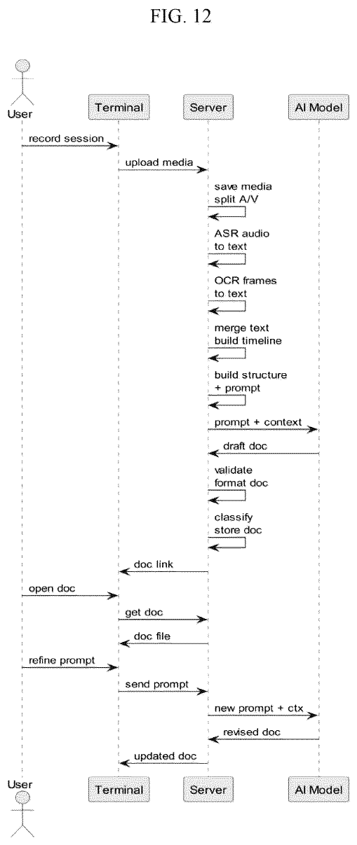

The following describes the processing flow using FIG. 12.

### Step 1:

The terminal acquires recording information. The terminal records audio information and image information of a meeting or training session using a microphone and a camera. The input is raw sensor data from the microphone and camera. The terminal encodes the sensor data into a media file that multiplexes an audio stream and a video stream and stores the media file in local storage. The output is a stored recording file containing the audio information and the image information.

### Step 2:

The terminal transmits the recording information to the server. The input is the stored recording file and optional metadata such as session title, equipment identifier, and language information. The terminal establishes a network connection to the server and uploads the recording file and the metadata using a network protocol. The output is a data transfer request that delivers the recording information and the metadata to the server.

### Step 3:

The server stores and registers the recording information. The input is the recording file and the metadata received from the terminal. The server writes the recording file into a storage region and creates a database record that includes a unique recording identifier, a file path, and the metadata. The server may compute a checksum of the recording file for integrity verification. The output is a registered recording identifier that references the recording information in the storage region.

### Step 4:

The server separates the audio information and the image information. The input is the recording file identified by the recording identifier. The server applies a media processing function to demultiplex the audio stream and the video stream. The server writes the separated audio stream into an audio file and writes the video stream into a video file. The output is an audio file containing audio information and a video file containing image information linked to the recording identifier.

### Step 5:

The server converts the audio information into character information. The input is the audio file and language information. The server samples the audio into time frames, computes acoustic features such as Mel-frequency cepstral coefficients or spectrogram values, and inputs the features into a trained speech recognition model. The speech recognition model computes probability distributions over text units and decodes the most likely text sequence for each time segment. The server aggregates these decoded sequences and associates each sequence with time information. The output is character information with time stamps that represent the recognized speech content.

### Step 6:

The server extracts frames from the video file. The input is the video file and a frame extraction policy such as a frame interval. The server reads the video stream frame by frame, selects frames according to the frame extraction policy, and writes each selected frame as an image file. The server records the time information for each frame based on the video time index. The output is a set of frame image files and a mapping between frame file identifiers and time information.

### Step 7:

The server converts the frame images into character information. The input is the set of frame image files and the associated time information. The server pre-processes each frame by operations such as resizing, gray-scaling, and binarization to enhance text regions. The server applies a character recognition technique to the processed frame and detects text regions, classifies character shapes, and assembles them into lines of text. The server associates the recognized character information with the time information of the corresponding frame. The output is character information from image data with time stamps representing on-screen text.

### Step 8:

The server integrates character information from audio and image sources. The input is time-stamped character information from the audio file and time-stamped character information from the frame images. The server aligns these pieces of character information along a common time axis by comparing their time information and grouping segments within specified temporal windows. The server labels segments as procedure information, safety information, or supplementary information by applying pattern matching rules and, optionally, a segment classification model. The output is time-series structured information that contains integrated and labeled character information with explicit temporal relationships.

### Step 9:

The server generates document structure data. The input is the time-series structured information and document type information, such as whether the target document is a procedure document or a safety document. The server selects a corresponding document template and maps labeled segments into template sections. The server arranges segments into ordered lists of steps, groups warnings into a safety section, and assigns supplementary text to background or notes sections. The output is document structure data that defines the organization of sections, headings, and content blocks without yet finalizing all wording.

### Step 10:

The server constructs a prompt sentence and a model input package. The input is the document structure data, the time-series structured information, and configuration parameters such as desired language and level of detail. The server composes a prompt sentence by combining fixed instruction phrases with variable elements that describe the document type, required sections, and style constraints. The server attaches selected segments of the time-series structured information as context, possibly summarizing or filtering them to fit a context size limit. The output is a prompt sentence and an associated context package that will be provided to the generative AI model.

### Step 11:

The server invokes the generative AI model to generate document content. The input is the prompt sentence and the context package. The server sends this input to a generative information processing model implemented as a neural network, which computes internal attention weights and generates token sequences that constitute proposed document content. The server receives the generated token sequences and decodes them into character information, preserving any indicated structure such as headings and numbered steps. The output is AI-generated document content that corresponds to the requested document type.

### Step 12:

The server validates and formats the AI-generated document content. The input is the AI-generated document content and the document structure data. The server checks for mandatory sections, verifies ordering of steps, and confirms the presence of safety-related phrases by applying rule-based validators. The server then merges the validated content into the document structure data and applies a document format to generate a document file with specific layout, styles, and numbering. The output is finalized document data in a specific file format stored in a temporary storage location.

### Step 13:

The server classifies and stores the document data. The input is the finalized document data and attribute information such as equipment identifiers, process identifiers, language, and creation time. The server determines a classification region within the storage region by applying mapping rules from attributes to storage paths or categories. The server writes the document data into the selected classification region and updates storage indexes to include the document identifier and its location. The output is stored document data associated with a classification region and a unique reference.

### Step 14:

The server provides reference information to related terminals. The input is sharing destination information and the stored document data reference. The server generates reference information such as a resource locator or a document identifier and transmits this reference information to terminals assigned as recipients, using communication channels such as messaging services or web notifications. The output is delivered reference information that allows related terminals to access the document data.

### Step 15:

The terminal retrieves and displays the document data. The input is the reference information received from the server. The terminal resolves the reference by contacting the server, requesting the document data, and downloading the corresponding file. The terminal opens the document in a viewer or editor application and renders the content on a display. The output is a visual representation of the generated document presented to the user.

### Step 16:

The user reviews the document and optionally provides a refinement prompt sentence. The input is the displayed document and the user's assessment of its content and style. The user examines the steps, safety instructions, and overall formatting, and, if necessary, enters a refinement prompt sentence such as “Simplify the language for novice operators and add a checklist at the end.” The user submits this prompt sentence to the server using the terminal interface. The output is a refinement prompt sentence that can be processed by the server to re-invoke the generative AI model with updated instructions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional computing environments, the generation of operation procedure documents and similar technical documents is largely dependent on manual authoring by human operators who review audio recordings, screen images, and other unstructured digital resources. This manual workflow requires that the operator listen to recorded speech, watch presentation screens frame by frame, and then manually distill and structure the content into a coherent document. As a result, the document creation process is time-consuming, error-prone, and difficult to scale.

Furthermore, even when automated speech recognition and optical character recognition are available as independent tools, these tools typically operate in isolation and do not provide an integrated mechanism to correlate audio-derived and image-derived character information. Without such correlation, important contextual relationships between spoken explanations and corresponding on-screen content are lost. This leads to incomplete or poorly structured procedure documents, and forces the user to perform additional manual editing and reconciliation.

In addition, generative AI models are increasingly capable of producing natural language documents, but existing systems generally require that a user manually craft a suitable prompt sentence and manually prepare source text for input. Conventional prompt design processes are ad hoc and non-deterministic, rely heavily on the skill of individual users, and do not exploit structured metadata such as time-series information or classification information derived from the original recording. Consequently, the quality and consistency of generated documents vary widely, and the underlying computing resources are not used in an optimal or repeatable manner.

From a computer technology perspective, existing document generation systems fail to provide: (i) an integrated data processing pipeline that automatically acquires multi-modal input (audio and image information) from communication platforms, (ii) a robust internal representation that unifies multi-source character information based on time-series or content features, and (iii) a deterministic prompt generation mechanism that systematically controls the behavior of a generative AI model. This absence of an integrated architecture lowers system-level efficiency, increases input/output overhead, and prevents the computing system from reliably producing high-quality procedural documents without extensive human intervention.

Accordingly, there is a need for an improved computer-implemented system that automatically acquires audio information and image information from recording data, converts such information into unified character information, generates a structured prompt sentence in a consistent and machine-controllable format, and supplies the prompt sentence and the unified character information to a generative AI model. Such a system should further manage the resulting document data within a document management platform and an information sharing platform in a manner that improves overall computing efficiency, reduces redundant user interactions, and stabilizes the quality of generated operation procedure documents.

The specific processing by the specific processing unit 290 of the data processing device 12 in Example 2 is realized by the following means.

The present invention provides a server comprising a processor configured to acquire audio information from recording data, convert the audio information into first character information by using a speech recognition processing component, acquire image information from the recording data as screen images at predetermined time intervals, extract second character information from the image information by using an optical character recognition processing component, integrate the first character information and the second character information based on at least one of time-series information and content information to generate integrated character information, generate a prompt sentence that defines document components, document sections, and document formatting of an operation procedure document in accordance with contents of the integrated character information, input the prompt sentence and the integrated character information into a generative information processing model to automatically generate the operation procedure document as document data, record the automatically generated operation procedure document in a document management platform together with classification information and access control information, and generate sharing identification information that enables the operation procedure document to be distributed to a user terminal via an information sharing platform. This enables an integrated and computer-implemented pipeline that automatically transforms multi-modal recording data into structured operation procedure documents, reduces manual interaction required for prompt design and document composition, and improves overall computer system efficiency and consistency in generating high-quality documents by controlling the operation of the generative AI model through a deterministically constructed prompt sentence and unified character information representation.

The term “audio information” refers to data representing sound captured from at least one acoustic input device and encoded in a digital format suitable for processing by a computing system.

The term “image information” refers to data representing visual content, including still images or video frames, captured from at least one visual output or display and encoded in a digital format suitable for processing by a computing system.

The term “first character information” refers to character data obtained by converting audio information into text by using a speech recognition processing component.

The term “second character information” refers to character data obtained by extracting text from image information by using an optical character recognition processing component.

The term “integrated character information” refers to character data generated by combining the first character information and the second character information based on at least one of temporal relationships and semantic relationships.

The term “speech recognition processing unit” refers to a hardware component, a software component, or a combination thereof configured to analyze audio information and output corresponding character information.

The term “optical character recognition processing unit” refers to a hardware component, a software component, or a combination thereof configured to analyze image information and output character information corresponding to text contained in the image information.

The term “time-series information” refers to temporal data associated with audio information and image information, including timestamps or timing indices indicating when particular portions of such information were captured or generated.

The term “content information” refers to semantic or contextual data associated with character information, including topics, terms, or labels that describe or categorize the meaning of the character information.

The term “prompt sentence” refers to a machine-readable instruction string that specifies constraints, requirements, or guidelines for document generation and that is provided as input to a generative information processing model.

The term “document components” refers to structural elements of a document, including sections, subsections, headings, paragraphs, lists, and annotations.

The term “document sections” refers to logically grouped portions of a document that are distinguished by headings or other markers and that each address a particular topic or operation.

The term “document formatting” refers to layout and style parameters of a document, including but not limited to fonts, headings, numbering schemes, list formats, emphasis styles, and arrangement of text blocks.

The term “operation procedure document” refers to a document that describes steps, actions, or workflows for executing one or more operations, including associated conditions, inputs, and cautions.

The term “generative information processing model” refers to a machine learning model, such as a neural network model, configured to generate natural language or other content based on one or more input prompts and associated context information.

The term “document data” refers to digital data representing the content and structure of a document, including text, metadata, and formatting information.

The term “document management platform” refers to an information processing environment, including at least one storage resource and at least one control component, configured to store, classify, and manage document data.

The term “classification information” refers to metadata associated with document data that indicates at least one category, tag, label, or taxonomy entry used for organizing or searching documents.

The term “access control information” refers to metadata associated with document data that specifies permissions, roles, or policies governing access to, or operations on, the document data.

The term “information sharing platform” refers to a network-based environment, including at least one server and at least one client interface, configured to distribute document data to one or more user terminals.

The term “sharing identification information” refers to data, such as a link, token, or identifier, that specifies an access path to a stored document and enables distribution of the document via an information sharing platform.

The term “recording data” refers to digital data that includes at least one audio stream and at least one video stream captured during a communication session, meeting, or presentation.

The term “screen image” refers to an image representing visual content displayed on a display device at a particular time, including an image extracted as a frame from video information.

The term “user terminal” refers to an information processing device operated by a user, such as a workstation, portable computer, or communication device, configured to send and receive data via a network and to present document data to the user.

In one embodiment, a server cooperates with at least one terminal operated by a user to implement a system for automatically generating operation procedure documents from recording data that includes audio information and image information. The server includes at least one processor, at least one memory storing program instructions and machine-learned parameters, a non-volatile storage device, and at least one network interface. The terminal includes at least one processor, a display device, at least one input device, and a network interface.

The user operates the terminal to execute communication software such as a conferencing application or presentation application. The terminal captures audio information from one or more microphones and captures image information corresponding to a graphical user interface or slide content displayed on a display device. The terminal encodes the captured information into recording data that comprises at least one audio stream and at least one video stream in a container format such as MP4, and transmits the recording data to the server via a communication network using a protocol such as HTTPS.

The server stores the received recording data in a storage device and executes a recording data processing program. The server uses a multimedia processing library, such as a tool of the type commonly known as FFmpeg or a similar media framework, to separate the audio stream and the video stream. The server decodes the audio stream into raw audio samples in a standardized sample rate (for example, 16 kHz) and channel configuration (for example, monaural). The server decodes the video stream into a sequence of frames and generates a plurality of screen images at predetermined time intervals, for example one frame every several seconds, by selecting frames at regular temporal offsets.

The server converts the raw audio samples into first character information by executing a speech recognition processing component. In one embodiment, the server invokes an automatic speech recognition (ASR) engine implementing a deep neural network, such as a recurrent neural network with long short-term memory units or a transformer-based acoustic model. The server segments the audio samples into overlapping windows, computes acoustic feature vectors such as Mel-frequency cepstral coefficients (MFCCs) or log-mel filter bank energies, and supplies the feature vectors to the ASR model. The ASR model is trained using supervised learning on labeled speech corpora so that the model parameters minimize a loss function such as a connectionist temporal classification (CTC) loss or a cross-entropy loss with respect to ground-truth transcriptions. During inference, the ASR model outputs symbol probabilities over a vocabulary of subword units or characters, and the server performs a decoding process, such as beam search with a language model, to generate textual tokens. The server assigns timestamps to the textual tokens based on alignment information from the ASR decoding process. The server thereby generates first character information as a structured data sequence in which each token or phrase is associated with a time index corresponding to a segment of the original audio stream. The server may store this first character information in a data structure such as a time-ordered list or a key-value map indexed by time segments.

The server converts the plurality of screen images into second character information by executing an optical character recognition (OCR) processing component. In one embodiment, the server uses an OCR engine of the type commonly referred to as an OCR library, such as an engine implementing a convolutional neural network (CNN) followed by a recurrent decoder. The server performs image preprocessing that includes converting each screen image to grayscale, normalizing brightness and contrast, applying binarization, and removing noise by morphological operations. The server segments text regions within the screen image using a text detection algorithm, such as a region proposal network or a sliding-window detector. For each text region, the server resizes the image patch to a fixed input size and supplies it to the OCR neural network.

The OCR neural network is trained using labeled image-text pairs and optimizes a loss function such as a categorical cross-entropy loss or CTC loss to map image features to character sequences. During inference, the OCR network outputs character sequences representing text displayed in each screen image. The server associates each recognized text segment with the timestamp of the corresponding frame from the video stream. The server thereby generates second character information as a structured set of textual segments labeled with frame indices and timestamps.

The server generates integrated character information by combining the first character information and the second character information based on at least one of time-series information and content information. In one embodiment, the server generates a unified timeline structure in which discrete time windows cover the duration of the recording data. The server assigns first character tokens from the ASR output and second character tokens from the OCR output to corresponding time windows according to their timestamps. The server applies content-based similarity measures, such as cosine similarity on vector embeddings of text segments produced by a sentence embedding model, to identify overlapping or complementary content. The server merges related text segments to form composite segments that combine spoken explanation and on-screen labels.

The server uses a rule-based module to standardize terminology and resolve conflicts. For example, the server maintains a domain-specific term dictionary that maps variant phrases or abbreviations to canonical terms. The server scans the integrated character information for occurrences of variant terms and replaces them with canonical forms. The server removes redundantly repeated phrases and low-information segments, such as repeated menu labels, by applying heuristic thresholds based on frequency, segment length, and position. The integrated character information thus forms a compressed and normalized representation of the recorded session, encoded as an ordered list of segments, each segment containing consolidated text, timestamps, and optionally metadata such as detected topics or operation types.

The server constructs a prompt sentence for a generative AI model based on the integrated character information. In one embodiment, the server includes a prompt generation module that applies deterministic rules to select document components, document sections, and document formatting conditions. The server analyzes the integrated character information using pattern recognition rules to identify candidate operation procedures, such as sequences beginning with verbs (“create,” “open,” “assign”) followed by direct objects (for example, “project,” “task”). The server groups such sequences into operation categories and uses these categories to define headings for document sections.

The server assembles the prompt sentence by inserting the detected operation categories into a template. An example of a prompt sentence is as follows:
“The following content includes (a) a speech transcript and (b) text extracted from screen captures of a training session about a new project management tool. Based on this information, generate a comprehensive and user-friendly operation manual.
   Create clear sections for: (1) how to create a new project, (2) how to assign tasks to team members, and (3) how to check project progress.
   Use numbered steps for each operation.
   Provide short explanations for each step.
   Highlight any important cautions, limitations, or prerequisites.
Source text:
   [here the server inserts the combined transcript and OCR text]”

The server appends the integrated character information as the “Source text” to the prompt sentence. The server thereby produces a combined input sequence that is deterministic for a given recording data and set of rules, which improves reproducibility and reduces variance in generated outputs across executions.

The server inputs the prompt sentence and the integrated character information into a generative information processing model. In one embodiment, the generative information processing model is a transformer-based neural network pre-trained on large-scale text corpora and fine-tuned for instruction following. The model includes an encoder-decoder architecture or a decoder-only architecture with multi-head self-attention layers, feed-forward subnetworks, and layer normalization. The server tokenizes the prompt sentence and the integrated character information using a subword tokenizer and constructs an input token sequence, which the server supplies to the generative model.

The generative model has parameters learned by minimizing a language modeling loss function, such as a cross-entropy loss between predicted tokens and target tokens, using gradient descent optimization with techniques such as Adam or AdamW. The model may be fine-tuned on a corpus of existing operation procedure documents so that the model learns domain-specific patterns such as step numbering, caution formatting, and procedural phrasing. During inference, the server sets generation parameters including maximum output length, temperature, and nucleus sampling threshold, and executes the generative model to produce output tokens that represent the operation procedure document.

The server receives the output tokens and decodes them into text. The server parses the generated text to identify document components such as headings, numbered lists, and caution statements. The server applies post-processing rules to enforce document formatting conditions, for example, ensuring that each section begins with a heading and that each step is represented as a numbered line. The server thereby obtains document data representing an operation procedure document.

The server stores the operation procedure document in a document management platform. The server associates classification information with the document, such as tags representing application category, functional area, and difficulty level. The server assigns access control information defining which user accounts or groups are permitted to view or modify the document. The server records this metadata in a data store, such as a relational database or a document-oriented database, and stores the document content in a file system or object storage system.

The server generates sharing identification information for the stored operation procedure document. The server generates a unique network resource identifier, such as a URL or token, that encodes or references the location of the document in the document management platform. The server registers this identifier in an information sharing platform and sets distribution policies accordingly. The server transmits the sharing identification information to the terminal or to another client device so that the user can access the operation procedure document via a web browser or a client application.

This configuration achieves technical effects beyond simple automation of human authoring. The server reduces redundant data transfers and processing by extracting and integrating character information in a single pipeline that leverages shared timestamp data, which lowers computational overhead compared to separate, uncoordinated processing of audio and image information. The server reduces memory usage by discarding intermediate raw data after generating integrated character information and document data, while still preserving sufficient context for document reconstruction. The server improves accuracy of generated documents by aligning speech and on-screen text, thereby avoiding omissions that arise when the two information sources are processed independently.

The server further improves computing efficiency by using deterministic prompt generation rules that minimize trial-and-error prompt engineering. Because the server automatically derives document components and formatting conditions from integrated character information, the generative model receives a well-structured and constrained prompt sentence, which reduces the number of tokens required and shortens inference time. The server reduces network load by transmitting a single compact representation of integrated character information to the generative model instead of raw audio or video data.

From a machine learning perspective, the integration of first character information and second character information constitutes an additional feature engineering step that provides the generative model with semantically enriched input. The integrated character information, including canonicalized terminology and time-aligned composite segments, serves as a specialized input representation that the generative model does not require to infer implicitly. This explicit integration reduces the complexity of the generative task, allowing a smaller or faster model configuration to achieve target quality levels, thereby improving runtime performance on the server.

In another embodiment, the server employs alternative architectures for the speech recognition processing component or the OCR processing component. The server may use a convolutional neural network with temporal convolution layers for acoustic modeling, or may employ a hybrid hidden Markov model/neural network architecture for speech recognition. The server may adopt a sequence-to-sequence OCR network with attention mechanisms to handle variable-length text regions in images. The server may also use alternative loss functions, such as focal loss for handling class imbalance in character prediction, or may adopt data augmentation techniques such as time masking, frequency masking, rotation, scaling, or noise injection to improve robustness during model training.

In a further embodiment, the server implements additional rule-based modules to adjust the integrated character information before providing it to the generative model. The server may use a finite-state machine or a context-free grammar to detect patterns representing multi-step operations and to label them with semantic tags. The server may maintain a rule table specifying that sequences containing particular keywords, such as “create,” “new,” and “project,” are mapped to a canonical operation category “project creation.” Such explicit rule-based categorization differs from human intuition and is executed at scale without fatigue, thereby enabling consistent and repeatable classification. The generative model, when receiving these labeled segments, can reliably structure the resulting document into predefined sections, leading to lower variance and higher consistency across generated documents.

In another embodiment, the terminal executes a client program that communicates with the server to display a preview of the operation procedure document in real time or near real time as the recording data is processed. The terminal can display incremental results, and the user can provide feedback, such as confirming or rejecting specific operation categories. The server may use this feedback as additional metadata to refine the integrated character information and update prompt generation rules. This interactive feedback loop can be used as a form of online learning or rule adjustment that improves technical performance of the system over time.

In still another embodiment, multiple servers cooperate within a distributed architecture. A first server may perform audio and video decoding and initial character extraction, while a second server executes the generative model. The servers exchange data using structured messages that contain integrated character information and prompt sentences. Load balancing components may distribute processing among several speech recognition instances or generative model instances based on current workload. Such a distributed configuration improves scalability and processing throughput, enabling the system to handle large volumes of recording data without degradation of processing speed.

Through these embodiments, the server, the terminal, and the user interact with specific hardware components and software modules in a coordinated manner. The system flexibly supports different communication software, recording formats, and generative models, while maintaining a consistent internal data structure for integrated character information and prompt sentences. As a result, the system provides a concrete technical implementation that improves processing speed, recognition accuracy, document consistency, and data management efficiency in comparison to conventional systems that rely either on manual authoring or uncoordinated application of speech recognition and OCR tools.

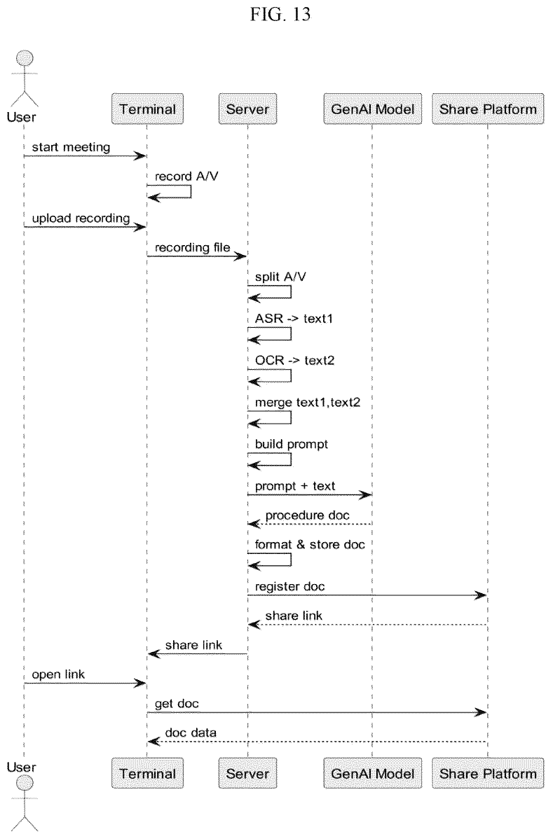

The following describes the processing flow using FIG. 13.

### Step 1:

The user operates the terminal to start a communication application and initiate a meeting or presentation. The terminal receives real-time audio from at least one microphone and screen output from a display subsystem as input. The terminal encodes the audio and video streams using a codec (for example, H.264 for video and AAC for audio), multiplexes them into a container format such as MP4, and outputs a recording file that contains at least one audio track and at least one video track stored in local storage.

### Step 2:

The user instructs the terminal to upload the recording file to the server after the meeting ends. The terminal reads the recording file as input, establishes a secure connection using a protocol such as HTTPS, and transmits the recording file as a binary data stream to the server. The server receives the binary stream as input, verifies integrity using checksums or content-length headers, writes the stream to persistent storage as a recording file, and outputs a storage path or identifier associated with the uploaded recording.

### Step 3:

The server retrieves the stored recording file based on the identifier and initiates media separation processing. The server uses a multimedia processing tool, such as a media framework library, as input to parse the container format and detect individual tracks. The server applies demultiplexing operations that separate the audio track and the video track, decodes the audio track into raw audio samples (for example, 16-bit PCM at 16 kHz mono), and outputs an audio file. The server also decodes the video track into raw frames and outputs a video frame stream for later processing.

### Step 4:

The server prepares audio data for speech recognition. The server takes the audio file as input, analyzes parameters such as sample rate, bit depth, and channel layout, and, if needed, performs signal processing operations, such as resampling, channel mixing, and normalization, to match the interface specifications of a speech recognition engine. The server outputs a normalized audio file that is temporally aligned with the original recording and suitable for feature extraction.

### Step 5:

The server converts the normalized audio file into first character information using a speech recognition processing unit. The server segments the audio into overlapping frames, computes acoustic feature vectors such as Mel-frequency cepstral coefficients from each frame, and supplies these vectors as input to a trained acoustic model implemented as a neural network. The speech recognition processing unit performs forward propagation to compute probability distributions over phonetic units or subword symbols for each time frame, and the server applies a decoding algorithm such as beam search or Viterbi decoding, optionally combined with a language model, to output a sequence of textual tokens with associated timestamps as first character information.

### Step 6:

The server extracts screen images from the video frame stream. The server takes the decoded video frames as input and applies a sampling rule that selects frames at predetermined time intervals (for example, one frame every few seconds) or when significant scene changes are detected. For each selected frame, the server converts the frame into an image object and encodes it in a standard image format such as PNG or JPEG. The server outputs a set of screen images, each labeled with a frame index and a timestamp corresponding to its position in the video stream.

### Step 7:

The server converts the screen images into second character information using an optical character recognition processing unit. The server takes each screen image as input, performs image preprocessing steps including grayscale conversion, contrast enhancement, binarization, and noise reduction, and runs a text detection algorithm that identifies bounding boxes likely to contain text. The server crops image patches from these bounding boxes and supplies them to an OCR neural network that generates character sequences. The server aggregates the recognized text strings for each screen image, attaches the associated timestamp and frame index, and outputs second character information as a structured set of timestamped text segments.

### Step 8:

The server generates integrated character information by combining the first character information and the second character information. The server takes as input the timestamped text tokens from the speech recognition processing unit and the timestamped text segments from the OCR processing unit. The server creates a unified timeline divided into discrete time windows and assigns speech-derived tokens and image-derived tokens to each time window based on their timestamps. The server further computes semantic similarity scores, for example using text embeddings and cosine similarity, to align related content. By merging text segments that fall within the same time window or share high semantic similarity, the server outputs integrated character information as an ordered list of consolidated segments, each segment including merged text, temporal metadata, and optional topic labels.

### Step 9:

The server normalizes and cleans the integrated character information. The server takes the consolidated segments as input and applies rule-based processing that replaces variant terminology with canonical terms using a domain dictionary, removes redundant repetitions of low-information labels, and corrects obvious transcription errors through spelling correction or heuristic rules. The server may also split overly long segments into smaller subsegments based on punctuation or topic shifts. The server outputs a refined set of integrated character segments that are compact, standardized, and suitable for direct use as source text for document generation.

### Step 10:

The server derives document structure elements from the refined integrated character information. The server analyzes each segment as input, searches for patterns indicating procedural actions, such as verb-object pairs and temporal markers (“first,” “then,” “next”), and groups related actions into operation categories. The server maps these categories to document sections such as setup operations, main operations, and verification operations. The server outputs a structural specification that enumerates document components including section headings, expected step counts, and required cautionary notes.

### Step 11:

The server constructs a prompt sentence based on the structural specification and the integrated character information. The server takes the list of operation categories and formatting constraints as input, selects an appropriate template for a generative AI model, and fills template placeholders with detected section titles and instructions on step formatting. The server then appends the cleaned integrated character segments as a source text block to the prompt sentence. As a result, the server outputs a prompt string that includes explicit instructions such as required sections, use of numbered steps, and highlighting of cautions, followed by the source text that the generative model should analyze.

### Step 12:

The server inputs the prompt sentence and the integrated character information to a generative AI model to generate an operation procedure document. The server tokenizes the prompt string and the appended source text as input tokens, feeds them into a transformer-based generative model that computes contextualized representations through multiple layers of self-attention and feed-forward operations, and iteratively predicts next tokens according to learned probability distributions. The server decodes the output tokens into text and obtains an initial draft of the operation procedure document, which includes headings, step-by-step instructions, and explanatory sentences as output.

### Step 13:

The server post-processes the generated operation procedure document to satisfy formatting and structural requirements. The server takes the generated text as input, parses it to identify headings, lists, and caution statements, and applies formatting rules that ensure each section's heading matches a defined operation category and that each operation is encoded as an ordered list item. The server may also enforce consistent terminology by reapplying the domain dictionary to the generated text. The server outputs a finalized document body in a structured internal representation, such as a tree of sections, paragraphs, and list items.

### Step 14:

The server converts the structured internal representation of the document into a document data file for storage and distribution. The server takes the structured representation as input and uses a document generation library to map sections and paragraphs to a target file format such as a word processing format or a portable document format. The server embeds metadata fields such as title, generation time, and author identifier, and encodes style information for fonts, page breaks, and numbering. The server outputs a document data file containing both content and layout information.

### Step 15:

The server registers the document data file in a document management platform. The server takes the document file and associated metadata as input, assigns classification information such as categories and tags based on the structural specification and integrated character information, and generates access control entries defining which users or groups may read, edit, or delete the document. The server writes the document file to a storage subsystem and stores an index record in a database that includes the file location, classification information, and access control information. The server outputs a document identifier referencing the stored document.

### Step 16:

The server generates sharing identification information so that the document can be accessed via an information sharing platform. The server takes the document identifier and access control settings as input and requests that the information sharing platform create an access endpoint, such as a unique URL or token, referencing the stored document. The information sharing platform returns a shareable link or identifier, and the server records this value as sharing identification information. The server outputs the sharing identification information to the terminal or to a notification channel so that the user can open the generated operation procedure document remotely.

### Step 17:

The user operates the terminal to access the generated operation procedure document using the sharing identification information. The terminal takes the shareable link or identifier as input, sends a retrieval request to the information sharing platform, and receives the document data file in response. The terminal decodes and renders the document on a display, allowing the user to view the document sections and follow the steps as instructions. The terminal may also allow the user to annotate or revise the document, and, if the user chooses to save changes, the terminal transmits updated document data back to the server, which overwrites or versions the stored document accordingly.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In environments where audio information and image information are captured during meetings, trainings, or field operations, conventional document generation systems typically perform a simple transcription of audio or a direct extraction of text from images, and then pass the resulting character information to a document template or a generative model. Such systems suffer from several technical drawbacks.

First, conventional systems generally treat audio-derived text and image-derived text as independent streams, without integrating them along a common time axis or annotating them with a unified source-type structure. As a result, the computing device has difficulty reliably associating spoken explanations with concurrently displayed content such as on-screen parameters or warning messages. This lack of structured association leads to inaccurate or incomplete procedure documents and requires additional manual correction, which reduces the efficiency and reliability of the information processing performed by the computer system.

Second, conventional systems do not utilize emotion information extracted from audio or text to guide the behavior of document generation and document management processes at the system level. Existing techniques may perform sentiment analysis for display or reporting, but they do not use emotion metadata as a first-class control signal that changes how a processor constructs a prompt sentence, how a generative model allocates detail to specific steps, or how a document classification module sets access-control metadata. Consequently, the computer system cannot automatically emphasize technically difficult or confusing portions in the generated document, and cannot automatically adapt sharing policies to risk-sensitive content. This limits the ability of the system to improve the quality and safety of downstream computer-assisted workflows.

Third, many existing systems merely pass raw or lightly pre-processed text into a generative model via a generic prompt. Such prompts are typically hand-crafted and static, and they do not encode a machine-generated structure that captures document type, section layout, emphasis rules, and sharing rules derived from integrated multi-source data and emotion signals. Without an automatically constructed, data-dependent prompt sentence, the generative model behaves as a black-box text generator and cannot be used as an integrated component of a larger, deterministic information-processing pipeline. This results in unstable output quality and prevents the system from consistently generating procedure-description-type documents that satisfy specific operational constraints.

Fourth, conventional systems are not configured to feed back the emotion-aware structure of the generated document into the storage and sharing layer implemented on an information storage device and a communication network. Document management is usually performed with static folder rules or manual tagging, independent of emotion-derived categories such as success cases or problem points. As a consequence, the computer system cannot automatically distinguish low-risk best-practice content from high-risk failure-related content, and cannot selectively distribute each class of content to different user groups with appropriately different access-control information.

Fifth, conventional systems that display generated documents on terminal devices, including visual display devices such as head-mounted displays, generally render large, undifferentiated text blocks and require users to manually scroll or navigate through the content. These systems do not automatically segment the document into work-procedure units linked to time-aligned data and do not emphasize, at the user-interface level, those units that have been determined by the processor to require special attention based on emotion information. This leads to increased cognitive load, slower task execution, and reduced safety, because the computing system does not optimize the presentation of procedural information for real-time guidance.

Accordingly, there is a need for a computer-implemented system that (i) integrates audio-derived and image-derived character information into structured, time-aligned information; (ii) associates emotion information with that structured information; (iii) uses the structured information and emotion information to automatically construct a prompt sentence that precisely defines document-generation conditions for a generative information processing model; (iv) edits the model output into a procedure-description-type document with emotion-aware emphasis and categorization; and (v) stores and shares the resulting document with differentiated access-control information, and presents it on a terminal device in a segmented, attention-guided manner. Such a system would improve the functioning of computers by enabling more accurate, reliable, and context-aware generation, management, and presentation of procedural documents from multi-modal input data.

The specific processing by the specific processing unit 290 of the data processing device 12 in Application Example 2 is realized by the following means.

The present invention provides a server comprising a processor configured to acquire audio information and convert the audio information into character information by using a speech recognition technique; to acquire image information and extract character information from the image information by using a character recognition technique; to integrate the character information on the basis of time information and information-source type in order to generate structured information in which spoken content and displayed content are associated with each other; to apply an emotion estimation technique to at least one of the audio information and the character information in order to obtain emotion information associated with the time information; to generate, on the basis of the structured information and the emotion information, a prompt sentence that defines document generation conditions including at least a document type, a document structure, a method of emphasizing important portions, and a sharing range, and to input the prompt sentence to a generative information processing model; to receive document data output from the generative information processing model and generate procedure-description-type document data by editing predetermined portions in the document data for emphasis display or supplementary explanation on the basis of the emotion information; and to add classification information and access-control information to the procedure-description-type document data, to store the procedure-description-type document data in an information storage device in accordance with a hierarchical structure, and to share the procedure-description-type document data so as to be referable from a terminal device via a communication network. This enables a computer system to automatically transform multi-modal input data into emotion-aware, procedurally structured documents with controlled distribution, thereby improving the technical performance of document generation, document management, and user-interface presentation in terms of accuracy, consistency, processing efficiency, and safety-oriented guidance.

The term “audio information” refers to information representing sound signals acquired from an acoustic sensor or an electronic file, including speech produced by a user during a meeting, training, or operation, and which is processable by a computing device.

The term “image information” refers to information representing visual signals acquired from an optical sensor or an electronic file, including still images or video frames in which text or graphical content is displayed, and which is processable by a computing device.

The term “speech recognition technique” refers to a computational technique for analyzing audio information and outputting corresponding character information by mapping acoustic features to linguistic units such as words or sentences.

The term “character recognition technique” refers to a computational technique for analyzing image information and extracting character information by detecting and recognizing textual patterns within the image information.

The term “character information” refers to digital textual data obtained by processing audio information with a speech recognition technique or image information with a character recognition technique, and represented in a machine-readable text format.

The term “time information” refers to data indicating a temporal position or duration associated with audio information, image information, or character information, such as timestamps, start times, end times, or frame indices.

The term “information-source type” refers to metadata indicating an origin category of character information, such as whether the character information was derived from audio information, from image information, or from another input modality.

The term “structured information” refers to data in which multiple pieces of character information are organized according to time information and information-source type, and in which spoken content and displayed content are associated with each other in a defined data structure.

The term “emotion estimation technique” refers to a computational technique for analyzing at least one of audio information and character information and outputting emotion information that indicates an estimated emotional state, such as confusion, anxiety, satisfaction, or excitement.

The term “emotion information” refers to digital data indicating one or more estimated emotional states and optionally their intensities, associated with time information, character information, or segments of audio information.

The term “prompt sentence” refers to a machine-readable textual instruction generated by a processor, which specifies document generation conditions and is provided as input to a generative information processing model.

The term “document generation conditions” refers to parameters that define how a document is to be generated by a generative information processing model, including at least a document type, a document structure, a method of emphasizing important portions, and a sharing range.

The term “document type” refers to a classification indicating a target kind of document to be generated, such as a maintenance procedure, an operation manual, a troubleshooting guide, or a meeting summary.

The term “document structure” refers to a layout specification of sections and subsections in a document, including elements such as titles, headings, numbered steps, warnings, notes, and summaries.

The term “method of emphasizing important portions” refers to a rule or set of rules defining how specific parts of a document are to be visually or logically highlighted, such as by using markers, formatting, or additional explanatory text based on emotion information.

The term “sharing range” refers to a scope of distribution of document data within an information system, including which user groups, organizational units, or access levels are permitted to access the document data.

The term “generative information processing model” refers to an information processing model that receives a prompt sentence as input and automatically generates document data in the form of natural language text or structured content.

The term “document data” refers to digital data representing a generated document, including text and optionally associated structure information such as headings, lists, and annotations.

The term “procedure-description-type document data” refers to document data that describes one or more work procedures in an ordered, step-wise manner, including instructions, conditions, and optional warnings for executing tasks.

The term “classification information” refers to metadata assigned to document data that indicates one or more categories or labels, such as a success-case category, a problem-point category, or a functional domain.

The term “access-control information” refers to metadata that defines access permissions for document data, including which users or groups may read, write, or share the document data.

The term “information storage device” refers to a hardware and software combination that stores digital data in a persistent manner, such as a storage subsystem or a network-accessible data repository.

The term “hierarchical structure” refers to an arrangement of storage locations or logical containers in a parent-child or multi-level relationship, such as folders, directories, or category trees used to organize document data.

The term “communication network” refers to a wired or wireless data transmission infrastructure that enables data exchange between the server and at least one terminal device.

The term “terminal device” refers to a computing apparatus operated by a user, including but not limited to a portable computing device, a display device, or a head-mounted display, which is capable of communicating with the server via a communication network.

The term “success-case category” refers to a classification category representing sections or documents that are associated with positive or desirable outcomes, as determined from structured information and emotion information.

The term “problem-point category” refers to a classification category representing sections or documents that are associated with problems, failures, confusion, or risk, as determined from structured information and emotion information.

The term “display information for a visual display device” refers to data specifying content, layout, and presentation parameters for rendering information on a visual display device, including step-wise procedure elements and emphasis indicators.

The term “work procedure unit” refers to a logically grouped subset of procedure-description-type document data that corresponds to a discrete operation or step to be performed by a user.

In one embodiment, a server implements the claimed system as a network-connected computing apparatus including at least one processor, a main memory, a non-volatile storage device, and a network interface. The server executes an operating system such as a general-purpose server operating system and runs a plurality of software modules implemented, for example, in a high-level programming language. The server communicates with at least one terminal operated by a user over a communication network such as a packet-switched network using a transport protocol.

The server uses specific software components to perform audio and image processing. The server employs an audio processing library such as a multimedia processing library to decode container files and extract an audio track as a waveform file with a predetermined sampling rate and channel configuration. The server invokes a speech recognition engine such as a cloud-based speech-to-text service via an application programming interface. The speech recognition engine internally uses an acoustic model and a language model, implemented for example by a deep neural network with convolutional and recurrent layers, trained on large-scale speech corpora. The server sends audio segments with attached language codes and model parameters to the speech recognition engine and receives transcribed character information with time stamps and confidence scores. By using such a specialized acoustic and language model rather than simple keyword spotting, the server improves the recognition accuracy for domain-specific terminology and allows a finer temporal alignment between speech and other modalities, which in turn improves downstream alignment and document quality.

The server uses an image processing framework such as a computer vision library to handle image information. The server decodes video frames from input files and resizes and normalizes the frames for optical character recognition. The server applies an optical character recognition engine such as an open-source OCR engine or a cloud-based vision service that implements a convolutional neural network and a sequence model for character detection and recognition. The OCR engine uses features such as gradient-based descriptors, convolutional feature maps, and recurrent decoding with a connectionist temporal classification loss during training. The server receives, for each image region, a sequence of characters with bounding boxes and confidence values. By operating on sampled frames at dynamically selected time points, such as at slide change detection based on frame differencing or histogram comparison, the server reduces redundant OCR calls and lowers computational and network load while preserving essential textual content from displays.

The server structures the character information into a specialized internal data format. The server stores each text segment as a record including fields such as: a time field (start time and end time), a source-type field (audio-derived or image-derived), a content field (text string), a confidence field, and an optional language tag. The server organizes these records in a time-sorted data structure such as a timeline list or an indexed table. The server also maintains cross-references between audio-derived segments and synchronously appearing image-derived segments, using nearest-neighbor matching on time stamps and source-specific alignment rules. This structured representation enables the server to perform later aggregation and prompt construction without repeatedly scanning raw files, thereby reducing memory usage and processing time and allowing deterministic reasoning about which text belongs to which operation phase.

The server applies an emotion estimation technique to audio information and/or character information. In one implementation, the server uses a neural network-based emotion classifier trained for speech emotion recognition. The classifier may be a multi-layer architecture with a front-end feature extractor computing features such as Mel-frequency cepstral coefficients and prosodic features, followed by a recurrent neural network or transformer network that models temporal patterns, and a dense output layer that produces a probability distribution over emotion categories such as joy, confusion, anxiety, and frustration. During training, the server or an external training infrastructure uses a set of labeled audio segments with human-annotated emotions, a loss function such as cross-entropy loss, and a weight update procedure such as stochastic gradient descent with momentum or Adam, and may apply data augmentation techniques such as time stretching, pitch shifting, and noise injection. In another implementation, the server uses a text-based emotion classification model that consumes character information and uses token embeddings, self-attention layers, and a classification head trained on emotionally labeled textual corpora.

The server receives, for each processed segment, emotion information consisting of category labels and numerical intensities, which are aligned by time to the structured information. The server stores this emotion information in an emotion field added to each record. This alignment of emotion information at the same granularity as the structured text allows the server to distinguish, for example, segments where a user expresses confusion while a particular parameter is shown on screen, from segments where the user expresses confidence, enabling emotion-aware prioritization and emphasis in later processing.

The server generates a prompt sentence for a generative AI model on the basis of the structured information and the emotion information. The server does not use a fixed, generic prompt. Instead, the server constructs a data-dependent prompt sentence using a rule-based prompt generator. The prompt generator module analyzes the timeline of records, clusters records into candidate steps based on temporal gaps and cue phrases such as “next,” “then,” and “finally,” and computes aggregate emotion statistics per cluster. The prompt generator then selects a document type (for example, maintenance procedure, operation manual, or troubleshooting guide) using configuration parameters or metadata, and generates a natural language instruction specifying the required section layout, numbering style, and emphasis rules.

For example, the server may generate the following prompt sentence:
“You are a technical writer. Using the following time-aligned data:
   Transcribed operator speech with timestamps and confidence scores.
   Text extracted from control panel screens and slides with timestamps.
   Emotion markers indicating confusion, anxiety, or enthusiasm for specific time ranges.
Generate a detailed maintenance procedure for the industrial robot used in this recording. Requirements:
   Output in English.
   Include sections: Purpose, Required Tools, Safety Warnings, Step-by-Step Procedure, Troubleshooting.
   Use numbered steps.
   For steps where confusion or anxiety was detected, add more detailed explanation and mark them with ‘IMPORTANT:’.
   Use text from control panel screens to name parameters and settings exactly. Data:
   [summary of segments here]”

In another example, when the input corresponds to a training session, the server may generate a prompt sentence such as:
“From this training session recording, generate an operation manual for the new machine. Use operator speech for explanations, use on-screen text for parameter names and values, and emphasize sections where trainees appeared confused by providing additional instructions and warnings.”

By encoding such detailed, structured conditions, the server transforms the generative AI model from a general-purpose text generator into a component of a specialized pipeline that receives a programmatically defined prompt sentence derived from specific multi-modal and emotional context. This reduces variance in model output and improves reproducibility and technical consistency of the generated documents.

The server uses a generative AI model that implements a neural language model architecture, such as a transformer decoder with multiple self-attention layers, feed-forward layers, and layer normalization. The model is pre-trained on a large corpus of text and then optionally fine-tuned on domain-specific procedure documents, using a training objective such as next-token prediction or sequence-to-sequence generation. During fine-tuning, the training process uses techniques such as mini-batch gradient descent, an adaptive optimizer, and regularization methods such as dropout. The server communicates with the generative AI model through an application programming interface and specifies hyperparameters such as a sampling temperature, a maximum token count, and a top-p parameter to balance diversity and determinism. The prompt construction rules and the chosen parameters cause the model to generate output that matches the procedural and structural constraints while maintaining fluency.

The server receives the document data produced by the generative AI model and further processes this document data to generate procedure-description-type document data. The server parses the text, recognizes section headers and step numbering, and inserts markup or structural metadata. The server inspects the emotion information associated with each step cluster and applies highlight rules. For steps corresponding to high confusion scores, the server inserts labels such as “IMPORTANT:” or “CAUTION:” and may request additional detail from the generative AI model by issuing a secondary prompt focusing on that step, thereby increasing the level of explanation and reducing ambiguity in critical parts. The server also generates summary sections such as “Success Cases” for segments with positive emotions and “Risk and Problem Points” for segments with negative emotions.

The server adds classification information and access-control information to the procedure-description-type document data. The server computes aggregate statistics such as the ratio of confused segments to total segments and uses rule-based or learned classifiers to assign categories such as success-case category or problem-point category. For instance, if the majority of emotions are positive and no high-risk warnings were recorded, the server assigns a success-case category; if significant confusion or anxiety is detected around error messages, the server assigns a problem-point category. The server maps each category to access-control policies stored in a configuration database. The server then writes metadata fields representing classification information and access-control information into a document record and into corresponding folder and sharing policies on an information storage device.

The server stores the procedure-description-type document data in an information storage device such as a network-attached storage system or a cloud storage service. The server uses a hierarchical structure such as nested directories or folder trees, where paths are computed from document metadata (for example, site, machine type, date, and category). By deterministically computing folder paths and tags from structured information and emotion information rather than letting users choose arbitrary paths, the server improves searchability and reduces misfiling, which constitutes a technical improvement in data management. The server interacts with the storage system via a network protocol and uses batch operations and caching to reduce communication overhead and latency.

The terminal is implemented as a computing device such as a portable terminal or a head-mounted display. The terminal includes a display unit such as a see-through display, input elements such as buttons, a touch interface, or a microphone, and a communication module. The terminal executes client software that communicates with the server using a network protocol. The terminal receives notifications about newly available procedure-description-type document data and retrieves only those parts of the document that are required for near-term display, such as the next few work procedure units, thereby reducing bandwidth consumption and improving responsiveness.

The server prepares display information for the terminal. The server segments the procedure-description-type document data into work procedure units, each corresponding to a discrete operation. The segmentation is derived from the time-aligned structured information and cue phrases rather than from simple page breaks, which ensures that each displayed unit aligns with a coherent action in the real world. For each unit, the server generates a compact representation, including the step title, a short instruction, and any relevant warnings or highlights derived from emotion information. The server also associates each unit with navigation metadata, such as a previous step and next step identifier.

The terminal receives this segmented display information and renders it step by step. When emotion information indicates that a particular work procedure unit requires special attention, such as when confusion or anxiety were detected during recording, the terminal emphasizes that unit by using graphical attributes such as color highlighting, enlarged fonts, icons, or audio cues. Because the terminal receives pre-segmented and emotion-annotated data, it does not need to perform expensive local text processing and can provide a stable low-latency user experience even on resource-constrained hardware.

The user operates the terminal during real-time work, such as performing maintenance on an industrial apparatus. The user follows the displayed steps, and, through simple interactions (for example, voice commands or button presses), the user advances to the next work procedure unit or revisits a previous unit. By aligning step presentation with the structured information and emotion information, the system ensures that difficult or risky operations are prominently displayed and not lost in long text blocks. This reduces error rates and shortens task execution time, thus providing a technical effect on the operation of the apparatus and on the computing system managing the information.

In some variations, the server includes an adaptive sampling algorithm for selecting frames and audio segments to be processed. For instance, the server detects low-motion segments and skips redundant OCR processing, or segments continuous speech into utterances using a voice activity detector. This selective processing reduces computational load and network traffic to external services while preserving the data needed for accurate document generation. In other variations, the server employs a caching layer that stores intermediate structured information and emotion information for re-use when regenerating documents with different document types or languages, improving efficiency and responsiveness.

In other embodiments, the generative AI model is deployed locally on the server rather than as a remote service. In such cases, the server stores the model weights in the information storage device and performs inference using optimized numerical libraries that exploit vectorized instructions or graphics processing units. The server may use quantization and model pruning to reduce memory footprint and inference time, resulting in lower latency and power consumption. The model architecture remains transformer-based, with multi-head attention and position embeddings, trained or fine-tuned with standard optimization algorithms and loss functions.

The described system does more than simply automate a human document-writing task. By introducing a specific internal data structure combining time, source type, and emotion information, and by using rule-based prompt generation that encodes document generation conditions into a prompt sentence tailored for a generative AI model, the server improves the way in which computers process and manage multi-modal data. The integration of emotion-aligned emphasis and access-control policies into the same computational pipeline yields more accurate, more consistent, and more efficient machine processing than previous systems that considered each modality and process step in isolation. This leads to technical improvements in recognition accuracy, prompt construction stability, generation consistency, storage organization, and user-interface responsiveness, and thereby constitutes an improvement to computer technology itself.

Multiple alternative configurations fall within this embodiment. The speech recognition engine, the OCR engine, the emotion classifier, and the generative AI model may be replaced by functionally equivalent components using different network architectures or probabilistic models. The rules for clustering segments into steps and for mapping emotion statistics to categories may be implemented as rule-based logic or as learned classifiers such as gradient-boosted decision trees. The terminal may be any device capable of rendering segmented procedure steps, including augmented-reality displays or handheld devices. In each case, the server continues to acquire audio and image information, generate structured and emotion information, construct a prompt sentence defining document generation conditions for a generative AI model, generate procedure-description-type document data, and store and share the data with classification and access-control information, so that the technical effects described above are maintained.

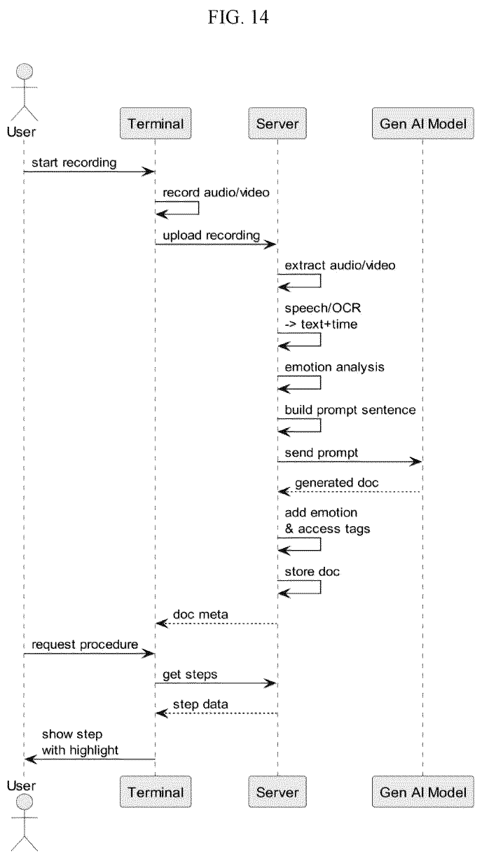

The following describes the processing flow using FIG. 14.

### Step 1:

Server acquires recording data from terminal.

Server receives, as input, a digital recording file containing audio information and image information from terminal via a communication network, for example an MP4 file uploaded over HTTPS. Server stores the file in a temporary storage area. Server parses the container headers to identify audio streams and video streams and records metadata such as duration, frame rate, and encoding parameters. The output of this step is a set of internal references to the stored recording file and its stream descriptors, which are used in later processing.

### Step 2:

Server extracts audio information and normalizes it.

Server takes, as input, the stored recording file reference and stream descriptors from Step 1. Server invokes an audio processing library to decode the audio stream and convert it into a waveform file with a fixed sampling rate and channel configuration (for example, 16 kHz, mono, linear PCM). Server segments the waveform into fixed-length or voice-activity-detected chunks and attaches time information to each chunk. The output of this step is a set of audio segments with associated start and end timestamps, which form the basis for speech recognition.

### Step 3:

Server performs speech recognition to generate character information from audio information.

Server receives, as input, the audio segments and their timestamps from Step 2. Server calls a speech recognition engine via an application programming interface, sending each audio segment along with parameters such as language code and acoustic model type. Server receives, in response, for each segment, a sequence of recognized words with time offsets and confidence scores. Server converts these results into character information records that include text content, start and end times, and confidence, and stores them in a structured data store. The output of this step is a time-aligned list of audio-derived character information.

### Step 4:

Server extracts image information from the recording and prepares it for character recognition.

Server takes, as input, the stored recording file reference and video stream descriptors from Step 1. Server uses a video processing library to decode frames at selected times, such as at fixed intervals or when frame differences exceed a threshold indicating a screen change. Server resizes and normalizes the extracted frames to a predefined resolution and color format suitable for optical character recognition. Server associates each frame with a frame timestamp based on its position in the video stream. The output of this step is a set of processed image frames with corresponding timestamps.

### Step 5:

Server applies character recognition to image information to obtain additional character information.

Server receives, as input, the processed image frames and their timestamps from Step 4. Server passes each frame to a character recognition engine, which detects text regions and recognizes characters. Server obtains, for each text region, a text string, region coordinates, and a confidence value. Server converts these results into image-derived character information records including text content, time information, source coordinates, and confidence. The output of this step is a time-aligned list of image-derived character information.

### Step 6:

Server integrates audio-derived and image-derived character information into structured information.

Server takes, as input, the audio-derived character information from Step 3 and the image-derived character information from Step 5. Server sorts all character information records by time information and annotates each record with an information-source type flag indicating audio source or image source. Server groups records that occur within a given time window into combined events and links related audio-derived text and image-derived text by computing time-based proximity and applying source-specific rules (for example, assuming that on-screen text at a given time supports the speech at the same time). The output of this step is structured information in which spoken content and displayed content are associated along a common time axis.

### Step 7:

Server performs emotion estimation on audio information and/or character information.

Server receives, as input, the audio segments from Step 2 and/or the audio-derived character information from Step 3. Server extracts features from the audio segments, such as spectral features and prosodic features, and feeds them into an emotion classifier, or tokenizes the character information and feeds it into a text-based emotion classifier. Server computes, for each segment, emotion scores for predefined categories (for example, confusion, anxiety, satisfaction, or excitement) and associates these scores with time information and segment identifiers. The output of this step is emotion information, consisting of emotion labels and intensities aligned with the time axis used in the structured information.

### Step 8:

Server augments structured information with emotion information.

Server takes, as input, the structured information from Step 6 and the emotion information from Step 7. Server matches emotion records to character information records by comparing time intervals and assigns the relevant emotion labels and scores to each structured record or group of records. Server calculates aggregated emotion profiles for contiguous time ranges, such as average confusion during a specific operation. The output of this step is emotion-annotated structured information that combines character information, source type, and emotion data.

### Step 9:

Server segments the emotion-annotated structured information into candidate work procedure units.

Server receives, as input, the emotion-annotated structured information from Step 8. Server analyzes time gaps, cue phrases in the character information (such as “next,” “then,” “finally”), and changes in image-derived content to identify boundaries between logical operations. Server groups records between boundaries into candidate work procedure units, each representing a potential step in a procedure. For each unit, server summarizes the main instruction, supporting on-screen text, and aggregated emotion statistics. The output of this step is a list of candidate work procedure units with associated textual summaries and emotion profiles.

### Step 10:

Server determines document generation conditions including document type, structure, emphasis method, and sharing range.

Server takes, as input, configuration data (such as use case or machine type) and the list of candidate work procedure units from Step 9. Server applies rule-based logic or a classifier to select a document type (for example, maintenance procedure or operation manual) and to decide on a document structure (section layout, numbering style). Server analyzes the aggregated emotion profiles to define a method of emphasizing important portions, such as marking steps with high confusion scores as “IMPORTANT,” and to propose a sharing range by mapping emotion-based categories (success case or problem point) to access-control policies. The output of this step is a set of document generation conditions that specify how the generative AI model should construct the document.

### Step 11:

Server constructs a prompt sentence for the generative AI model based on structured information and document generation conditions.

Server receives, as input, the emotion-annotated structured information from Step 8, the candidate work procedure units from Step 9, and the document generation conditions from Step 10. Server summarizes the structured information into a compact textual description, including representative examples of operator speech, on-screen text, and emotion markers. Server then programmatically assembles a prompt sentence that instructs the generative AI model to generate a specific type of document with the required structure and emphasis rules. For example, server may generate:
“You are a technical writer. Using the following time-aligned data:
   Transcribed operator speech with timestamps and confidence scores.
   Text extracted from control panel screens and slides with timestamps.
   Emotion markers indicating confusion, anxiety, or enthusiasm for specific time ranges.
Generate a detailed maintenance procedure for the industrial machine used in this recording.
Requirements:
   Output in English.
   Include sections: Purpose, Required Tools, Safety Warnings, Step-by-Step Procedure, Troubleshooting.
   Use numbered steps.
   For steps where confusion or anxiety was detected, add more detailed explanation and mark them with ‘IMPORTANT:’.
   Use text from control panel screens to name parameters and settings exactly.
Data:
   [summary of segments here]”

The output of this step is a complete prompt sentence ready to be sent to the generative AI model.

### Step 12:

Server invokes the generative AI model using the constructed prompt sentence.

Server takes, as input, the prompt sentence from Step 11. Server sends the prompt sentence to a generative AI model endpoint via a network interface, specifying parameters such as maximum output length and sampling behavior. Server waits for the model to process the prompt and to generate natural language document data. Server receives, as output, a draft document that includes a title, sections, numbered steps, warnings, and explanatory text, all aligned with the instructions encoded in the prompt sentence.

### Step 13:

Server refines and edits the document data into procedure-description-type document data using emotion information.

Server receives, as input, the draft document data from Step 12 and the emotion-annotated structured information from Step 8. Server parses the draft document to identify the mapping between generated steps and original work procedure units based on textual similarity and references to parameters or timestamps. Server uses the emotion information associated with each work procedure unit to adjust the document: for steps with high confusion or anxiety, server inserts “IMPORTANT:” markers, adds extra explanatory sentences, or expands troubleshooting subsections; for steps with positive emotions, server may add brief notes indicating successful strategies. The output of this step is procedure-description-type document data that has been customized according to emotion information.

### Step 14:

Server assigns classification information and access-control information to the procedure-description-type document data.

Server takes, as input, the procedure-description-type document data from Step 13 and the aggregated emotion profiles from Step 9. Server computes overall emotion trends, such as the fraction of time steps labeled as high confusion or high enthusiasm. Server applies decision rules to assign classification information: if the document is dominated by successful, low-confusion segments, server labels it as a success-case category; if the document contains many high-confusion or error-related segments, server labels it as a problem-point category. Server then maps these classifications to access-control policies stored in configuration data, generating access-control information such as permitted user groups and confidentiality levels. The output of this step is the procedure-description-type document data enriched with classification information and access-control information.

### Step 15:

Server stores the classified document in an information storage device according to a hierarchical structure.

Server receives, as input, the classified procedure-description-type document data from Step 14. Server computes a folder path in a hierarchical structure based on metadata such as facility identifier, machine type, date, and classification category. Server converts the document data into a storage format (for example, a structured text or document file) and writes it to the computed folder path on an information storage device or external storage service. Server also registers the document's location, classification, and access-control information in an index or database. The output of this step is a persistently stored document that is organized within a hierarchical structure and prepared for controlled access.

### Step 16:

Server shares the stored document so that terminal can access it via a communication network.

Server takes, as input, the stored document reference and the access-control information from Step 15. Server generates a document identifier or a network resource locator and configures sharing settings on the storage system or within its own access layer in accordance with the access-control information. Server then makes the document discoverable to authorized terminals by exposing it through an application programming interface or a directory listing endpoint. The output of this step is a network-accessible document endpoint with enforced access-control policies.

### Step 17:

Terminal acquires segmented display information for the procedure-description-type document data.

Terminal receives, as input, a notification or query result from server indicating the availability of a new or requested procedure-description-type document. Terminal sends a request to server specifying the document identifier and possibly a current step index. Server responds with display-oriented segments, each representing one work procedure unit, including text content, emphasis markers derived from emotion information, and navigation metadata. Terminal stores these segments temporarily in local memory. The output of this step is a local representation of procedure segments ready for display.

### Step 18:

Terminal presents work procedure units to user with emotion-based emphasis.

Terminal takes, as input, the segmented display information from Step 17. Terminal renders one work procedure unit at a time on its display device, using layout rules that highlight segments marked as requiring special attention, such as by applying different colors or icons to steps that have high confusion or anxiety scores. Terminal listens for user input, such as a voice command or button press, to move to the next or previous step, and fetches additional segments from server if needed. The output of this step is a sequence of visual displays that guide user through the procedure and focus attention on technically critical or emotionally difficult steps.

### Step 19:

User executes physical operations while referencing the displayed procedure-description-type document data.

User receives, as input, the step-by-step instructions and emphasized warnings displayed by terminal from Step 18. User interprets the instructions and performs corresponding actions on physical equipment, such as adjusting settings, replacing components, or verifying operating states. User may provide feedback to terminal, such as marking a step as unclear or completed. The output of this step is a real-world execution of the procedure guided by the emotion-aware, structurally generated document, which in turn can be logged by server for future analysis or document refinement.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

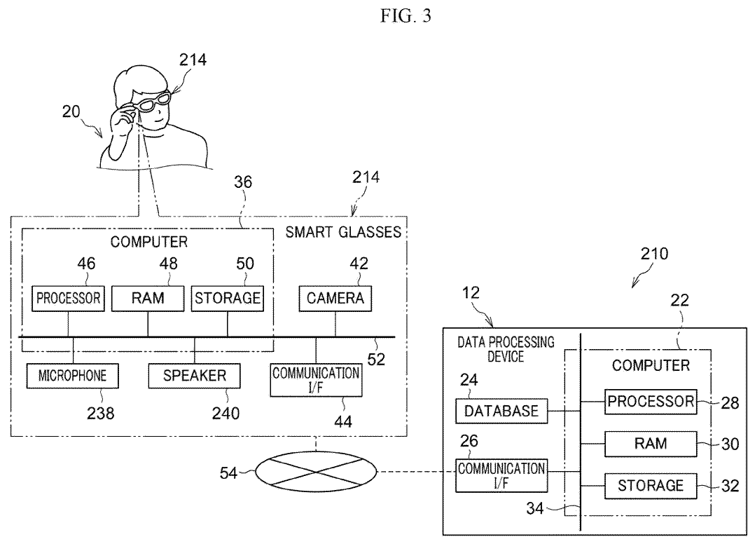

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

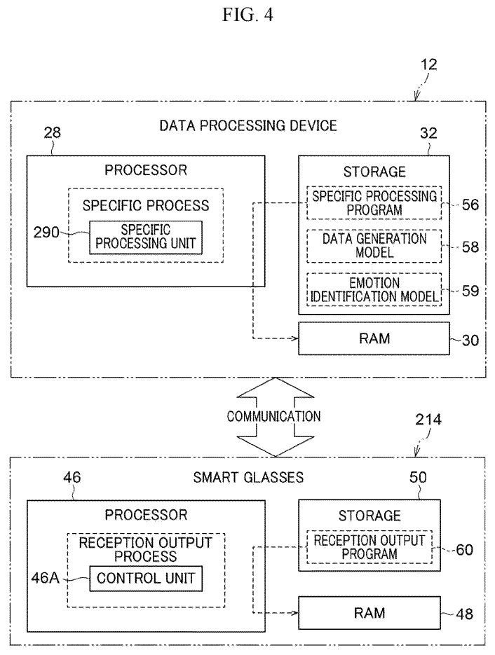

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

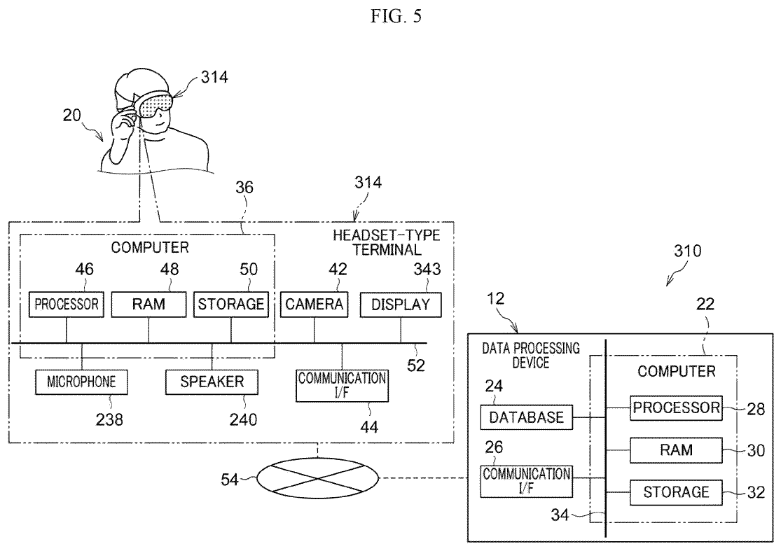

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

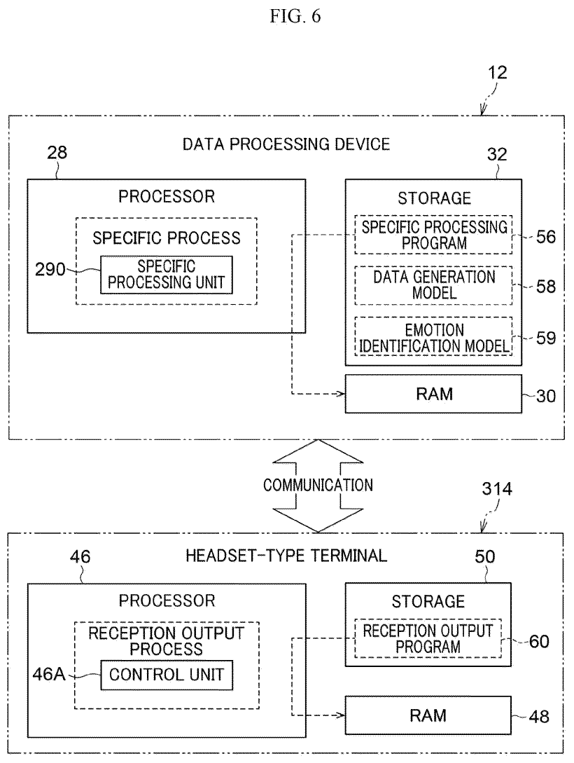

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

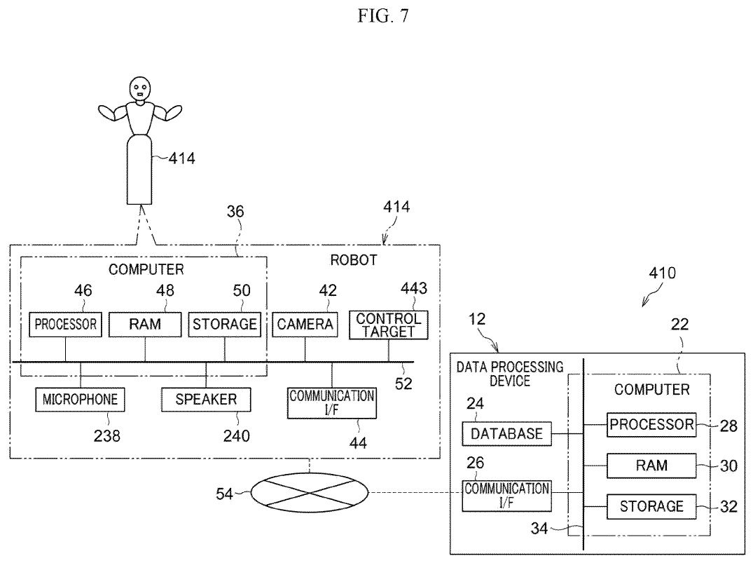

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

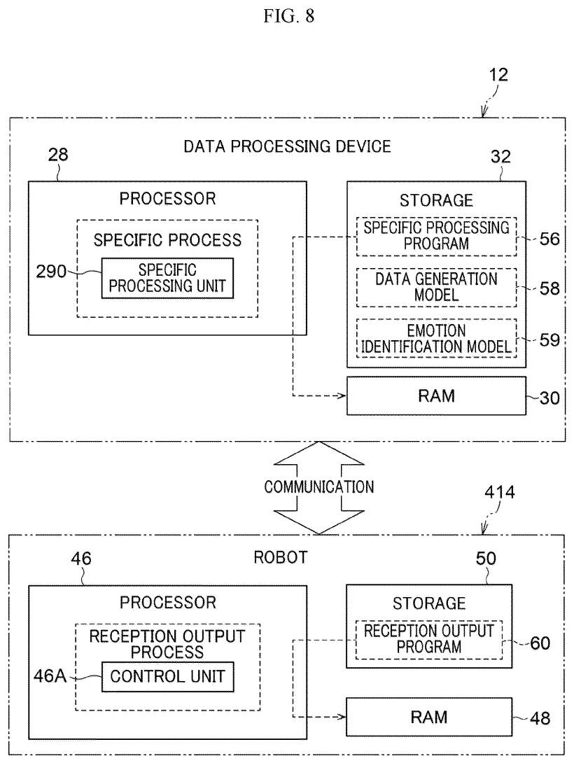

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

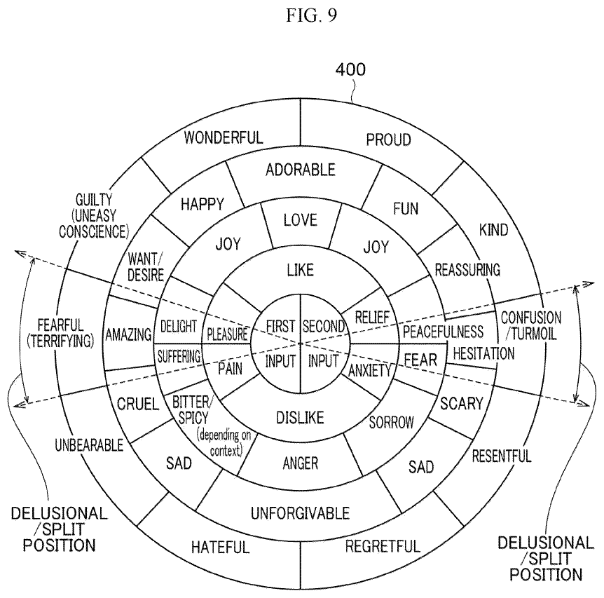

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

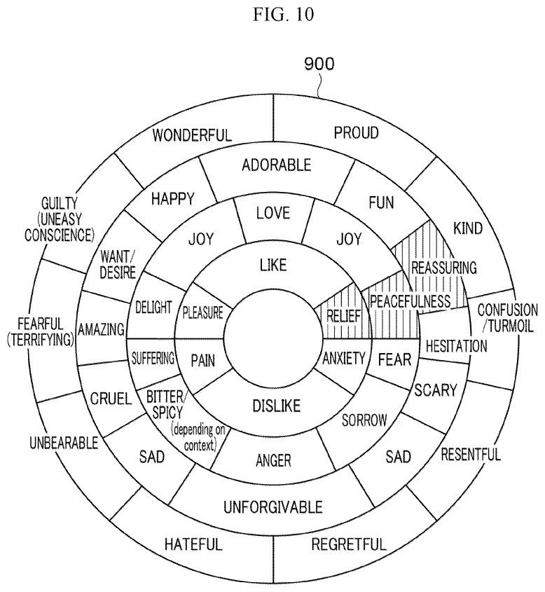

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire audio information from recording information and convert the audio information into character information by using a speech recognition process,
acquire image information from the recording information and convert the image information into character information by using an image recognition process,
associate character information based on the audio information and character information based on the image information with each other on the basis of time information and generate integrated text information,
generate a prompt sentence that defines instruction content including a document type, structural elements, and a description style for a document, on the basis of the integrated text information,
input the prompt sentence and the integrated text information to a generative information processing model and cause the generative information processing model to automatically generate the document,
structure document information output from the generative information processing model into document data according to a predetermined format and store the document data in a document storage region,
assign classification information to the document data on the basis of meeting information or case information, and arrange the document data on the basis of the classification information and generate sharing identification information, and
transmit notification information including the sharing identification information to a user terminal by using a communication process.

### (Supplementary 2)

The system according to supplementary 1,
wherein the processor is configured to treat the recording information as recording data of a meeting or a presentation acquired via a communication process, to treat the audio information as an audio component included in the recording data, and to treat the image information as an image component included in the recording data.

### (Supplementary 3)

The system according to supplementary 1,
wherein the processor is configured to cause the prompt sentence to include at least one of a minutes type, a procedure type, and a summary type as the document type, a heading structure corresponding to the document type, and an extraction condition for work items, so as to improve work efficiency and document quality by inputting the prompt sentence to the generative information processing model.

Application Example 1

### (Supplementary 1)

A system comprising a processor,
wherein the processor is configured to
acquire audio information and convert the audio information into character information by using a speech recognition technique,
acquire image information and extract character information from the image information by using a character recognition technique,
integrate the acquired character information on the basis of time information to generate time-series structured information including procedure information, safety information, and supplementary information,
generate document structure data in accordance with a document format for a procedure document or a safety document on the basis of the time-series structured information and document type information,
generate a prompt sentence including content for instructing automatic generation of a document on the basis of the document structure data, and input the prompt sentence and the time-series structured information into a generative information processing model,
convert document content output from the generative information processing model into document data in a format conforming to the document format, and
store the document data automatically in a predetermined classification region within a storage region on the basis of attribute information included in the document data and provide reference information to the document data to a related terminal on the basis of sharing destination information.

### (Supplementary 2)

The system according to supplementary 1,
wherein the processor is configured to extract the audio information and the image information from recording information of a meeting or a training session acquired by a communication processing apparatus, generate a plurality of screen images from video information included in the recording information, and apply the character recognition technique to each of the screen images.

### (Supplementary 3)

The system according to supplementary 1,
wherein the processor is configured to set the prompt sentence to include content for instructing the generative information processing model to create a standardized document including work procedure information or safety guideline information, thereby improving work efficiency and document quality.

### Example 2

### (Supplementary 1)

A system comprising a processor,
wherein the processor is configured to
acquire audio information; and
convert the audio information into first character information by using a speech recognition processing unit; and
acquire image information; and
extract second character information from the image information by using an optical character recognition processing unit; and
integrate the first character information and the second character information based on at least one of time-series information and content information to generate integrated character information; and
generate a prompt sentence, which defines document components, document sections, and document formatting of a document, in accordance with contents of the integrated character information; and
input the prompt sentence and the integrated character information into a generative information processing model so as to automatically generate, as document data, an operation procedure document; and
record the automatically generated operation procedure document in a document management platform and store the operation procedure document with classification information and access control information; and
generate sharing identification information that enables the stored operation procedure document to be distributed to a user terminal via an information sharing platform.

### (Supplementary 2)

The system according to supplementary 1,
wherein the processor is configured to
extract the audio information from recording data generated by at least one of a conference function and a presentation function provided on a communication platform, and acquire the image information as screen images obtained at predetermined time intervals from video information included in the recording data.

### (Supplementary 3)

The system according to supplementary 1,
wherein the processor is configured to
cause the prompt sentence to define operation categories, operation procedures, cautionary information, and formatting conditions to be included in the operation procedure document, and to improve at least one of work efficiency and document quality by automatic generation of the operation procedure document by the generative information processing model.

### Application Example 2

### (Supplementary 1)

A system comprising a processor,
wherein the processor is configured to
acquire audio information and convert the audio information into character information by using a speech recognition technique,
acquire image information and extract character information from the image information by using a character recognition technique,
integrate the character information on the basis of time information and information-source type to generate structured information in which spoken content and displayed content are associated with each other,
apply an emotion estimation technique to the audio information or the character information to obtain emotion information associated with the time information,
generate a prompt sentence that defines document generation conditions including a document type, a document structure, a method of emphasizing important portions, and a sharing range on the basis of the structured information and the emotion information, and input the prompt sentence to a generative information processing model,
receive document data output from the generative information processing model and generate procedure-description-type document data by editing predetermined portions in the document data for emphasis display or supplementary explanation on the basis of the emotion information, and
add classification information and access-control information to the procedure-description-type document data, store the procedure-description-type document data in an information storage device in accordance with a hierarchical structure, and share the procedure-description-type document data so as to be referable from a terminal device via a communication network.

### (Supplementary 2)

The system according to supplementary 1,
wherein the processor is configured to classify sections related to successful work as a success-case category and classify sections related to problem occurrence or confusion as a problem-point category on the basis of the structured information and the emotion information, and to share the document data with mutually different access-control information for the respective categories.

### (Supplementary 3)

The system according to supplementary 1,
wherein the processor is configured to, on the basis of display information for a visual display device acquired at the terminal device, divide the procedure-description-type document data into units of work procedures and sequentially display the units, and to emphasize and present display information corresponding to a work procedure determined to require attention on the basis of the emotion information so as to improve work efficiency and work safety.

What is claimed is:

1. A system comprising:
a communication interface coupled to a packet-switched network; and
circuitry configured to:
acquire audio information and image information from recording information received via the communication interface;
convert the audio information into first character information by executing a speech recognition process, and convert the image information into second character information by executing an image recognition process;
associate the first character information and the second character information with each other based on time information to generate integrated text information;
generate a prompt defining instruction content comprising a document type, structural elements, and a description style based on the integrated text information, and input the prompt and the integrated text information to a generative neural network model to cause the generative neural network model to generate document information; and
structure the document information into document data according to a predetermined format, store the document data in a storage device, and transmit the document data to a terminal device via the packet-switched network.

2. The system according to claim 1, wherein the speech recognition process comprises converting the audio information into a sequence of phoneme representations, applying a language model to decode the phoneme representations into word sequences, and generating timestamped text segments each associated with a time interval.

3. The system according to claim 2, wherein the image recognition process comprises extracting frames from the image information at predetermined intervals, applying optical character recognition to each extracted frame to generate frame-level character data, and associating the frame-level character data with corresponding time intervals.

4. The system according to claim 3, wherein associating the first character information and the second character information comprises aligning the timestamped text segments with the frame-level character data based on overlapping time intervals to produce time-synchronized text-image pairs in the integrated text information.

5. The system according to claim 4, wherein the circuitry is further configured to detect speaker transitions in the audio information based on voice characteristic changes and to annotate the integrated text information with speaker identifiers corresponding to each timestamped text segment.

6. The system according to claim 1, wherein the prompt comprises a structured template format including fields for document type specification, section heading definitions, formatting constraints, and a style parameter indicating at least one of formal, instructional, or summary description modes.

7. The system according to claim 6, wherein the circuitry is further configured to extract key terms and topic labels from the integrated text information using natural language processing comprising named-entity recognition and keyword extraction, and to embed the extracted key terms and topic labels into the prompt as contextual parameters.

8. The system according to claim 7, wherein the generative neural network model generates the document information comprising a plurality of document sections each including a section heading, body text, and cross-references to related sections, and wherein the circuitry validates that each section includes non-empty heading and body text fields.

9. The system according to claim 8, wherein the circuitry is further configured to apply post-processing to the document information comprising consistency checking between cross-references, formatting normalization, and insertion of figure references corresponding to extracted image frames.

10. The system according to claim 1, wherein the circuitry is further configured to assign classification information to the document data based on metadata extracted from the recording information comprising at least meeting identifiers, participant identifiers, and topic keywords.

11. The system according to claim 10, wherein the circuitry is further configured to generate sharing identification information based on the classification information, and to transmit notification information including the sharing identification information and an access link to one or more terminal devices via the packet-switched network.

12. The system according to claim 1, wherein the recording information comprises a recording from a communication platform, and wherein the circuitry acquires the recording information by retrieving a stored recording file from the communication platform via an application programming interface.

13. The system according to claim 1, wherein the circuitry is further configured to receive feedback information from a terminal device indicating corrections or modifications to the document data, construct an update prompt incorporating the feedback information and the document data, and input the update prompt to the generative neural network model to generate revised document information.

14. The system according to claim 13, wherein the circuitry is further configured to compare the revised document information with the prior document data to identify modified sections, and to store a version record associating the prior document data and the revised document information with respective version identifiers.

15. The system according to claim 1, wherein the circuitry is further configured to perform emotion estimation on the audio information by analyzing prosodic features comprising pitch contour, speaking rate, and energy variation, and to annotate the integrated text information with emotional-state labels for each timestamped segment.

16. The system according to claim 1, wherein the document data comprises a procedure manual generated from the recording information, and wherein the structural elements comprise sequential step descriptions, prerequisite conditions, and expected outcomes.

17. The system according to claim 16, wherein the circuitry is further configured to calculate a completeness score for the document data by comparing extracted step descriptions against a reference checklist stored in the storage device, and to flag incomplete sections for supplementary generation.

18. A system comprising:
a communication interface coupled to a packet-switched network; and
circuitry configured to:
acquire recording information via the communication interface, the recording information comprising audio information and image information with associated time information;
convert the audio information into timestamped text segments by executing speech recognition comprising phoneme decoding and language model application, and convert the image information into frame-level character data by executing optical character recognition on frames extracted at predetermined intervals;
associate the timestamped text segments and the frame-level character data based on overlapping time intervals to generate integrated text information, and extract key terms and topic labels from the integrated text information using named-entity recognition;
generate a prompt comprising a structured template format including document type specification, section heading definitions, formatting constraints, style parameters, and the extracted key terms as contextual parameters, and input the prompt and the integrated text information to a generative neural network model to generate document information comprising a plurality of document sections;
structure the document information into document data according to a predetermined format, assign classification information based on metadata from the recording information, and store the document data in a storage device; and
generate sharing identification information and transmit the document data and notification information to terminal devices via the packet-switched network.

19. The system according to claim 18, wherein the circuitry is further configured to receive feedback information from a terminal device, construct an update prompt incorporating the feedback information and the document data, and input the update prompt to the generative neural network model to generate revised document information with version tracking.

20. A method comprising:
acquiring, by circuitry coupled to a packet-switched network, audio information and image information from recording information;
converting the audio information into first character information by executing a speech recognition process, and converting the image information into second character information by executing an image recognition process;
associating the first character information and the second character information based on time information to generate integrated text information;
generating a prompt defining instruction content comprising a document type, structural elements, and a description style based on the integrated text information, and inputting the prompt and the integrated text information to a generative neural network model to generate document information;
structuring the document information into document data according to a predetermined format, storing the document data in a storage device, and transmitting the document data to a terminal device via the packet-switched network.
